(19) United States
(12) Patent Application Publication
(10) Pub. No.: US 2025/0208289 A1
(43) Pub. Date: Jun. 26, 2025

(54) Locationing with Bluetooth-Assisted Ultra-Wide Band Ranging

(71) Applicant: Cisco Technology, Inc., San Jose, CA (US)

(72) Inventors: Raj Taneja, Twinsburg, OH (US); Ardalan Alizadeh, Campbell, CA (US); Matthew Silverman, Shaker Heights, OH (US); Peiman Amini, Fremont, CA (US); Rabe Arshad, Milpitas, CA (US)

(21) Appl. No.: 18/919,336

(22) Filed: Oct. 17, 2024

Related U.S. Application Data
(60) Provisional application No. 63/614,381, filed on Dec. 22, 2023.

(51) Int. Cl. G01S 13/87; G01S 13/76; H04W 76/14

(52) U.S. Cl. CPC G01S 13/878; G01S 13/765; H04W 76/14

(57) ABSTRACT

Devices and methods for locationing with Bluetooth-assisted Ultra-Wide Band (UWB) ranging are provided. To support UWB ranging based on a Bluetooth Low Energy (BLE) out-of-band mechanism, establishing a BLE connection for each of a plurality of network devices is not feasible. To allow client devices to autonomously determine their location, virtual BLE addressing with shared keys is implemented. A client device configures first and second UWB ranging exchanges associated with first and second network device sets, respectively, based on bonding data associated with virtual Bluetooth addresses. The client device obtains first and second UWB ranging data and transmits the first or second UWB ranging data to a cloud for locationing. Based on the reuse of the virtual Bluetooth addresses across the first and second network devices sets, the client device perceives the same known set of network devices for connection rather than the plurality of network devices.

This application claims the benefit of U.S. Provisional Patent Application No. 63/614,381, filed Dec. 22, 2023, which is incorporated by reference herein in its entirety.

The present disclosure relates to wireless networks. More particularly, the present disclosure relates to locationing with Bluetooth-assisted Ultra-Wide Band (UWB) ranging.

### BACKGROUND

Wireless networks have become an integral part of modern communication systems, providing connectivity to a wide range of devices. One of the aspects of these wireless networks is the ability to accurately determine the location of the devices within a wireless local area network, especially in indoor environments where Global Navigation Satellite System (GNSS)-based location services, including, for example, Global Positioning System (GPS) services, may not be effective. Locationing solutions may allow for pinpointing the location of a device within a given space based on wireless signals. Locationing solutions may rely on different types of location measurements associated with different types of location technologies and their associated wireless transmissions.

Tracking the precise location of managed devices is challenging in enterprises, for example, office buildings, hospitals, warehouses, conference venues, shopping malls, or the like, since GPS signals are attenuated indoors. While ranging techniques, for example, Wi-Fi® or Bluetooth® ranging techniques, may be utilized in some cases to determine the location of a device, such technologies typically provide limited location accuracy. Ultra-Wide Band (UWB), as defined in the Institute of Electrical and Electronics Engineers (IEEE) 802.15.4a and 802.15.42 specifications, may offer improved ranging accuracy over Wi-Fi and Bluetooth.

Generally, UWB technology may be used for determining a location of an object in a space based on Time-of-Flight (ToF) of radio frequency (RF) signals between devices. Due to its operating frequencies, which enable reliable signal transmission and reception even in an environment with obstacles in the signal path, UWB technology can be used to determine centimeter-scale location. However, configuration and initiation of UWB sessions in an automated fashion over a large network are challenging. A conventional mechanism for Out-Of-Band (OOB) configuration exchange between devices in UWB technology may be entirely linked to Bluetooth Low Energy (BLE) connectivity. Presently, while UWB technology may be included in many client devices, for example, smartphones, users are unaware of UWB functionality, as its activation is solely performed through BLE. The BLE protocol may be utilized as the main OOB configuration exchange mechanism of the UWB protocol. BLE may serve as a tool for the initial setup and configuration of UWB-enabled devices. The configuration process is performed using a different OOB communication channel than the main UWB channel to ensure that UWB can operate effectively for its intended tasks. Once the devices are properly configured via BLE, the devices can use UWB for functions such as location tracking.

Network systems may include multiple access points in a geographic area, such as a building or other enterprise structure. Access points may refer to hardware network devices that facilitate connection of wireless devices to a wired network or a wireless network in the geographic area. For example, a building may include one or more networks for communication of data between different devices associated with the network(s). Some buildings may include a relatively large number of access points installed throughout the building, often in locations that are not readily apparent. IEEE 802.11az and 802.11-2016 (fine timing measurements “FTM”) facilitate an exchange of ranging messages between two stations, for example, between a client device such as a smartphone and an access point, so that relative positions between the two stations may be determined. In a real enterprise scenario, the BLE OOB configuration exchange mechanism may be utilized to support UWB two-way ranging between stations, for example, between a client device and multiple access points. However, establishing a BLE connection between a client device and each of the numerous access points in an enterprise for configuring and initiating UWB sessions may not be feasible.

### SUMMARY OF THE DISCLOSURE

Devices and methods for locationing with Bluetooth-assisted Ultra-Wide Band (UWB) ranging in accordance with embodiments of the disclosure are described herein.

In many embodiments, a client device comprises a processor, a network interface controller configured to provide access to a network, and a memory communicatively coupled to the processor. The memory comprises a location logic that is configured to configure a first set of Ultra-Wide Band (UWB) ranging exchanges associated with a first set of network devices based on at least a part of bonding data associated with a plurality of virtual Bluetooth addresses, perform the first set of UWB ranging exchanges, and obtain first UWB ranging data based on the first set of UWB ranging exchanges. The location logic is further configured to configure a second set of UWB ranging exchanges associated with a second set of network devices based on at least a part of the bonding data associated with the plurality of virtual Bluetooth addresses, perform the second set of UWB ranging exchanges, obtain second UWB ranging data based on the second set of UWB ranging exchanges, and transmit the first UWB ranging data or the second UWB ranging data.

In a variety of embodiments, a first network device in the first set of network devices and a second network device in the second set of network devices are different network devices. Further, a first UWB ranging exchange in the first set of UWB ranging exchanges is configured with the first network device based on bonding data associated with a virtual Bluetooth address in the plurality of virtual Bluetooth addresses. Furthermore, a second UWB ranging exchange in the second set of UWB ranging exchanges is configured with the second network device based on the bonding data associated with the virtual Bluetooth address in the plurality of virtual Bluetooth addresses.

In a number of embodiments, the first set of UWB ranging exchanges and the second set of UWB ranging exchanges comprise two-way UWB ranging exchanges.

In further embodiments, the plurality of virtual Bluetooth addresses comprises a plurality of virtual Bluetooth Low Energy (BLE) virtual addresses.

In more embodiments, the location logic is further configured to obtain first fingerprint data associated with the first set of network devices, obtain second fingerprint data associated with the second set of network devices, and transmit the first fingerprint data or the second fingerprint data.

In additional embodiments, the first fingerprint data and the second fingerprint data are obtained via a set of Bluetooth communications.

In numerous embodiments, the first fingerprint data comprises a first set of Media Access Control (MAC) addresses for the first set of network devices, and the second fingerprint data comprises a second set of MAC addresses for the second set of network devices.

In several embodiments, the location logic is further configured to receive a first location determination for the client device based on the first UWB ranging data and the first fingerprint data or receive a second location determination for the client device based on the second UWB ranging data and the second fingerprint data.

In yet more embodiments, one or more of the first UWB ranging data, the first fingerprint data, the second UWB ranging data, or the second fingerprint data are transmitted to a network device, and the first location determination or the second location determination is received from the network device.

In still more embodiments, the bonding data associated with the plurality of virtual Bluetooth addresses comprises, for each virtual Bluetooth address, a long-term key.

In still yet embodiments, the location logic is further configured to participate in a set of pairing and bonding processes associated with the plurality of virtual Bluetooth addresses.

In still yet more embodiments, for each virtual Bluetooth address in the plurality of virtual Bluetooth addresses, the long-term key is generated during a respective pairing and bonding process in the set of pairing and bonding processes.

In many further embodiments, the bonding data associated with the plurality of virtual Bluetooth addresses is stored during the set of pairing and bonding processes.

In still additional embodiments, a network device comprises a processor, a network interface controller configured to provide access to a network, and a memory communicatively coupled to the processor. The memory comprises a location logic that is configured to receive an indication of a plurality of virtual Bluetooth addresses, receive bonding data associated with the plurality of virtual Bluetooth addresses, wherein the bonding data is further associated with one or more client devices, configure a set of network devices in a plurality of network devices with the plurality of virtual Bluetooth addresses and the bonding data, and rotate the plurality of virtual Bluetooth addresses and the bonding data to additional network devices in the plurality of network devices.

In further additional embodiments, the plurality of virtual Bluetooth addresses comprises a plurality of virtual BLE addresses.

In yet additional embodiments, the plurality of network devices is under management by the network device.

In various embodiments, the bonding data associated with the plurality of virtual Bluetooth addresses comprises, for each pair comprising a virtual Bluetooth address and a client device, a long-term key.

In yet various embodiments, the location logic is further configured to store the plurality of virtual Bluetooth addresses and the bonding data in a datastore.

In several additional embodiments, the plurality of virtual Bluetooth addresses and the bonding data are rotated based on at least one of historical client device location data or a machine learning process.

In several more embodiments, a method for determining a location of a client device. The method comprises configuring a first set of UWB ranging exchanges associated with a first set of network devices based on at least a part of bonding data associated with a plurality of virtual Bluetooth addresses, performing the first set of UWB ranging exchanges, and obtaining first UWB ranging data based on the first set of UWB ranging exchanges. The method further comprises configuring a second set of UWB ranging exchanges associated with a second set of network devices based on at least a part of the bonding data associated with the plurality of virtual Bluetooth addresses, performing the second set of UWB ranging exchanges, obtaining second UWB ranging data based on the second set of UWB ranging exchanges, and transmitting the first UWB ranging data or the second UWB ranging data.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a conceptual network diagram of various environments in which a location logic may operate on a plurality of network devices in accordance with various embodiments of the disclosure;

FIG. 2 is a schematic block diagram of a wireless environment showing locationing with Bluetooth-assisted Ultra-Wide Band (UWB) ranging in accordance with various embodiments of the disclosure;

FIG. 3 is a schematic diagram of a conceptual database maintained by a controller of network devices in accordance with various embodiments of the disclosure;

FIG. 4 is a flowchart depicting a process for locationing with multiple rounds of Bluetooth-assisted UWB ranging in accordance with various embodiments of the disclosure;

FIG. 5 is a flowchart depicting a process for locationing with a single round of Bluetooth-assisted UWB ranging in accordance with various embodiments of the disclosure;

FIG. 6 is a flowchart depicting a process for configuring a plurality of network devices with virtual Bluetooth Low Energy (BLE) addresses in accordance with various embodiments of the disclosure;

FIG. 7 is a flowchart depicting a process for configuring a plurality of network devices with virtual BLE addresses in accordance with various embodiments of the disclosure;

FIG. 8 is a flowchart depicting a process for configuring a network device with different virtual BLE addresses in accordance with various embodiments of the disclosure; and

FIG. 9 is a conceptual block diagram for a network device capable of executing components and logic for implementing the functionality and embodiments described above.

Corresponding reference characters indicate corresponding components throughout the several figures of the drawings. Elements in the several figures are illustrated for simplicity and clarity and have not necessarily been drawn to scale. For example, the dimensions of some of the elements in the figures may be emphasized relative to other elements for facilitating understanding of the various presently disclosed embodiments. In addition, common, but well-understood, elements that are useful or necessary in a commercially feasible embodiment are often not depicted to facilitate a less obstructed view of these various embodiments of the present disclosure.

### DETAILED DESCRIPTION

In response to the issues described above, devices and methods are discussed herein for locationing with Bluetooth-assisted Ultra-Wide Band (UWB) ranging. In many embodiments, the devices and methods discussed herein may implement autonomous device location tracking using UWB and Bluetooth Low Energy (BLE) technologies. In an example, UWB may operate in the range of about 3.1 gigahertz (GHz) up to about 10.6 GHZ, while BLE may operate in the 2.4 GHZ radio band connecting devices to form a personal area network. In a number of embodiments, the devices and methods discussed herein may implement a UWB technique for device tracking through large scale access point deployments, utilizing BLE radios that share keys. In a variety of embodiments, the devices and methods discussed herein may utilize virtual BLE addressing with the shared keys to allow client devices, for example, smartphones, to autonomously determine their locations in large scale access point deployments. By defining limited virtual BLE addresses and reusing the defined limited virtual BLE addresses, the devices and methods discussed herein may allow a client device to perceive few network devices, for example, access points, as available for connection rather than numerous access points deployed in an enterprise scenario.

UWB, as defined in Institute of Electrical and Electronics Engineers (IEEE) 802.15.4a and 802.15.4z, may offer accurate ranging for a UWB-enabled client device. Ranging can be used, for example, for detecting and/or tracking a location of a client device. UWB ranging may refer to a UWB localization technique, that is, a localization technique involving UWB transmissions. UWB ranging may include, for example, Time-of-Flight (ToF), Time-of-Arrival (ToA), Time-Difference-of-Arrival (TDoA), Received Signal Strength Indicator (RSSI), and/or other analyses of the UWB transmissions. UWB ranging can be relatively precise, providing ranging accuracy within, for example, about 10 centimeters (cm), in Line-of-Sight (LoS) situations. This level of ranging accuracy is useful for both client-driven and infrastructure-based applications. UWB technology can utilize a low-energy density for short range measurements and perform high-bandwidth signaling over a large portion of the radio spectrum. The bandwidth of UWB may be, for example, greater than about 500 megahertz (MHz). UWB communication may occur between two devices that can initiate ranging by identifying each other and exchanging ranging parameters. The ranging parameters may include, for example, local address, complex channel, session key, or the like. The ranging parameters may rotate or otherwise change after a ranging session ends and need to be recommunicated to restart ranging. Applications deployed on the devices may implement the exchange of ranging parameters by utilizing a secure Out-Of-Band (OOB) mechanism, for example, Bluetooth Low Energy (BLE). OOB may refer to any communication of data via a dedicated channel, separate from that normally utilized for the transmission of data.

In a real enterprise scenario, the BLE OOB configuration exchange mechanism may be utilized to support UWB two-way ranging between stations, for example, between a client device and multiple access points. UWB two-way ranging may refer to a two-way communication between two devices, which may include a measurement of the ToF of a UWB Radio Frequency (RF) signal between the devices. The distance between the two devices may be calculated, for example, by multiplying a roundtrip time of the UWB RF signal by the speed of light, and then dividing the result by 2. Consider an example where the distance between a client device and an access point may need to be measured to determine the location of the client device. The client device may be configured to operate as a “tag” that needs to be tracked or located, and the access point may be configured to operate as an “anchor”, that is, a fixed reference point within a wireless network that communicates with the tag. Anchors may receive signals from tags and utilize the information included therein to determine the location of the tags. In the above example scenario, to measure the distance between the client device and the access point, a plurality of messages may need to be exchanged between them. The client device may initialize UWB two-way ranging by transmitting a “poll” message to a known address of the access point in time, herein referred to as “Time of Sending Poll (TSP). The access point may then record a Time of Reception of Poll (TRP), and reply with a response message at a Time of Sending Response (TSR). The client device, upon receiving the response message, may then record the Time of Response Reception (TRR) and compose a final message including, for example, its ID, TSP, TRR and Time Start Final (TSF). Based on the time of reception of this final message, the access point can determine the Time of Flight of the UWB RF signal.

In large scale access point deployments in an enterprise scenario, establishing BLE connections to multiple access points for configuring and initiating UWB two-way ranging sessions, which allow the determination of the location of the client device, may not be feasible. In other words, to support UWB two-way ranging based on the BLE OOB configuration exchange mechanism to localize a client device, in a real enterprise scenario, establishing a new BLE connection per access point may not be feasible. For example, if there are thousands of access points in a campus, all the access points cannot be stored as a unique/independent device. In various embodiments, the devices and method discussed herein address this issue by defining only a limited number of virtual BLE addresses and reusing the limited number of virtual BLE addresses to allow the client device to perceive that there are only few access points available for connection instead of thousands. In more embodiments, the devices and methods discussed herein may utilize virtual BLE addressing with shared keys to allow the client device to autonomously determine its location in large scale access point deployments. Further, in additional embodiments, the devices and methods discussed herein may allow for UWB locationing and/or ranging to a UWB-enabled device by establishing and sharing multiple BLE Media Access Control (MAC) addresses across multiple access points.

In further embodiments, the devices and method discussed herein may allow autonomous indoor locationing of a client device using UWB and BLE technologies as follows. Consider an example of locationing an enterprise-managed client device such as a smartphone in a large-scale access point deployment including a plurality of access points. The client device is paired and bonded to a predetermined number of different virtual BLE peripherals. Pairing may refer to a process of establishing a connection between two devices to allow communication and exchange of data including, for example, passcodes, Personal Identification Numbers (PINs), or the like between them. Bonding may refer to a more persistent form of pairing, where pairing information and encryption keys are stored in both the devices to allow the devices to automatically reconnect thereafter without having to undergo the pairing process again. Virtual BLE may utilize virtual beacons instead of physical beacons to more precisely locate devices including BLE sensors for providing indoor location-based services. In the above example, the client device is paired and bonded to a plurality of different virtual BLE peripherals, for example, six, seven, eight, etc. In this example scenario, the virtual BLE peripherals may be access points. Each access point, in this example, may be a BLE device uniquely identified by a 48-bit value herein referred to as a “BLE address”. A virtual BLE address may refer to a temporary or dynamically generated address configured to obscure an identity of an access point. The access point may generate a virtual BLE address, which is used in its advertisements to establish a BLE connection with the client device. In still more embodiments, a locationing application is deployed on the client device. In still further embodiments, the locationing application may be executable by at least one processor of the client device and configured to perform locationing with BLE-assisted UWB two-way ranging. The locationing application, running on the client device, may coordinate the pairing process, in operable communication with an underlying operating system of the client device.

Once the bonding process is completed, in still additional embodiments, the client device and the access points, each may generate long-term keys to authenticate and encrypt future communication between them. The client device may then share these long-term keys with a controller configured to manage the access points. On receiving the long-term keys from respective client devices, the controller associated with the access point may create a database of bonded client devices. As the client device travels around a site covered by the access points, the locationing application on the client device may periodically perform ranging, for example, dual-sided, two-way ranging over UWB, with the access points, in the form of ranging sessions. In some more embodiments, the locationing application on the client device may configure these ranging sessions over BLE connections with the bonded access points. When the UWB ranging completes, the locationing application on the client device may transmit the results as ranging data to a remote service, for example, cloud. In yet various embodiments, as a part of the ranging data that the client device collects to upload to the cloud may be a fingerprint that is unique to each access point. The fingerprint may allow a ranging engine in the cloud to determine which physical access point ranged with the client device during a ranging session. In yet more embodiments, the fingerprint may be one of the MAC addresses or any other physical addresses of the access points. In still yet more embodiments, the locationing application on the client device may collect this fingerprint, for example, as a BLE Generic ATTribute (GATT) characteristic.

In an example scenario, the locationing application on the client device may range with at least three (3) access points during each of these periods or ranging sessions to allow the cloud to determine a precise physical location of the client device using multilateration. Multilateration, also known as hyperbolic positioning, may refer to a process of locating the client device by determining, to a configured accuracy, a TDoA of a signal emitted from the client device to three or more access points. In an example, when the locationing application on the client device ranges with three access points during each of the ranging sessions, trilateration may be utilized for determining the precise physical location of the client device. In this example scenario, the six virtual BLE addresses with which the client device is paired and bonded may roam around the network of access points. In many further embodiments, the virtual BLE addresses may not be tied to individual access points for the roaming function. These bonded virtual BLE addresses may exist virtually and may be configured to the access points in the deployment by the controller along with the database of long-term keys bonded with those virtual BLE addresses. The controller may execute this configuration to allow the client device to communicate with all the access points in the network over BLE without having prior knowledge of the existence of each access point. This configuration allows the client device to perceive the same six known virtual BLE peripherals or access points as available for establishing BLE connections. Periodically, for example, every few minutes or every few hours, the controller may rotate the six virtual BLE addresses to different access points in the network to create different clusters of devices. The controller may rotate these six virtual BLE addresses around the deployment to ensure that the client device operating as a “BLE Central” can see only one instance of each virtual BLE address.

In many additional embodiments, the controller may determine the rotation of the virtual BLE addresses within the network via machine learning to allow these virtual BLE addresses to roam around access points physically located near where the client device was previously located. The machine learning-based determination of the rotation allows generation of higher quality location data of the client device while also freeing up BLE radios to perform other tasks in those areas of the deployment where client devices are not often located.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like), or an embodiment combining software and hardware aspects that may all generally be referred to herein as a “function,” a “module,” an “apparatus,” or a “system.” Furthermore, aspects of the present disclosure may take the form of a computer program product embodied in one or more non-transitory computer-readable storage media storing computer-readable and/or executable program code. Many of the functional units described in this specification have been labeled as functions, to emphasize their implementation independence more particularly. For example, a function may be implemented as a hardware circuit comprising custom Very Large Scale Integration (VLSI) circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, a procedure, or a function. Nevertheless, the executables of an identified function need not be physically located together but may comprise disparate instructions stored in different locations which, when joined logically together, comprise the function and achieve the stated purpose for the function.

A function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, an apparatus, a processor, or a device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a Printed Circuit Board (PCB) or the like. Each of the functions and/or modules described herein, in still yet further embodiments, may alternatively be embodied by or implemented as a component.

A circuit, as used herein, comprises a set of one or more electrical and/or electronic components providing one or more pathways for electrical current. In still yet additional embodiments, a circuit may include a return pathway for electrical current, so that the circuit is a closed loop. In several embodiments, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In numerous embodiments, a circuit may include a portion of an integrated circuit, an integrated circuit, a set of integrated circuits, a set of non-integrated electrical and/or electrical components with or without integrated circuit devices, or the like. In numerous additional embodiments, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as a field programmable gate array, a programmable array logic, a programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a PCB or the like. Each of the functions and/or modules described herein, in further additional embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B, or C” or “A, B, and/or C” mean “any of the following: A; B; C; A and B; A and C; B and C; A, B, and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

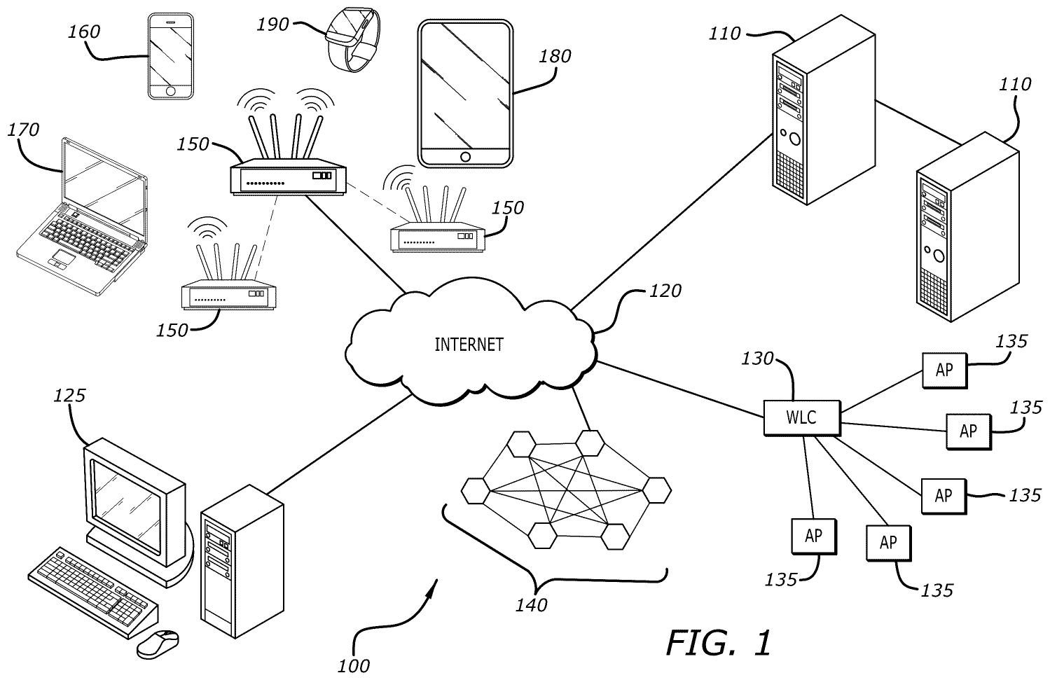

Referring to FIG. 1, a conceptual network diagram 100 of various environments in which a location logic may operate on a plurality of network devices in accordance with various embodiments of the disclosure is shown. Those skilled in the art will recognize that the location logic can include various hardware and/or software deployments and can be configured in a variety of ways. In many embodiments, the location logic can be configured as a standalone device, exist as a logic in another network device, be distributed among various network devices operating in tandem, or remotely operated as part of a cloud-based network management tool. In a number of embodiments, one or more servers 110 can be configured with the location logic or can otherwise operate as the location logic. In a variety of embodiments, the location logic may operate on one or more servers 110 connected to a communication network 120 (shown as the “Internet”). The communication network 120 can include wired networks or wireless networks. The location logic can be provided as a cloud-based service that can service remote networks, such as, but not limited to a deployed network 140.

However, in various embodiments, the location logic may be operated as a distributed logic across multiple network devices. In the embodiment depicted in FIG. 1, a plurality of network access points 150 can operate as the location logic in a distributed manner or may have one specific device operate as the location logic for all the neighboring or sibling access points 150. The access points 150 may facilitate Wi-Fi® connections for various electronic devices, such as but not limited to, mobile computing devices including cellular phones 160, laptop computers 170, portable tablet computers 180, and wearable computing devices 190.

In more embodiments, the location logic may be integrated within another network device. In the embodiment depicted in FIG. 1, a Wireless Local Area Network (WLAN) controller (denoted as “WLC”) 130 may have an integrated networking logic that the WLC 130 can utilize to monitor or control power consumption of a plurality of access points (denoted as “APs”) 135 that the WLC 130 is connected to, either wired or wirelessly. In additional embodiments, a personal computer 125 may be utilized to access and/or manage various aspects of the location logic, either remotely or within the network itself. In the embodiment depicted in FIG. 1, the personal computer 125 communicates over the communication network 120 and can access the location logic of the servers 110, or the network access points 150, or the WLC 130.

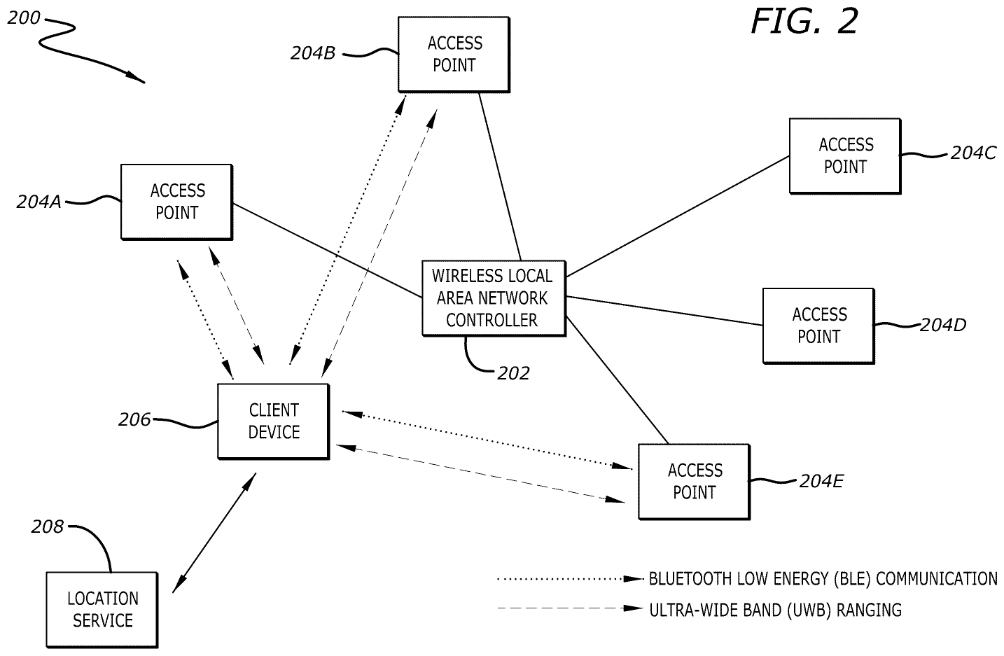

Although a specific embodiment for various environments in which a location logic may operate on a plurality of network devices suitable for carrying out the various steps, processes, methods, and operations described herein is discussed with respect to FIG. 1, any of a variety of systems and/or processes may be utilized in accordance with embodiments of the disclosure. For example, the location logic may be provided as a device or a software separate from the WLC 130 or the location logic may be integrated into the WLC 130. The elements depicted in FIG. 1 may also be interchangeable with other elements of FIGS. 2-9 as required to realize a particularly desired embodiment.

Referring to FIG. 2, a schematic block diagram of a wireless environment 200 showing locationing with Bluetooth-assisted Ultra-Wide Band (UWB) ranging in accordance with various embodiments of the disclosure is shown. In many embodiments, the wireless environment 200 may deploy a Wireless Local Area Network (WLAN). The WLAN may allow a plurality of devices, for example, access points 204A, 204B, 204C, 204D, and 204E (hereinafter, the access points 204A, 204B, 204C, 204D, and 204E are collectively referred to as “the access points 204A-E”) and client devices to communicate with each other and connect to a network, for example, the Internet, wirelessly, within a large geographic area such as an enterprise. The WLAN may utilize radio waves to transmit data between the devices. In a number of embodiments, the devices in the WLAN may be configured to operate in accordance with the Institute of Electrical and Electronics Engineers (IEEE) 802.15 wireless communication technology, for example, UWB, BLE, or the like. In WLAN deployments, there may be multiple wireless access points, for example, access points 204A-E, which serve one or more wireless client devices (e.g., the client device 206), also known as STAs or clients. The access points 204A-E may refer to networking devices, for example, wireless routers, which allow wireless-capable devices, for example, client devices such as smartphones, to connect to a wired network. The wired network may be a wired local area network, for example, the Ethernet. The access points 204A-E may provide wireless connectivity to the client devices and act as bridges between the WLAN and the wired network. Although the wireless environment 200 in FIG. 2 shows five access points 204A-E, the wireless environment 200 can include any number of access points. In a variety of embodiments, the access points 204A-E can communicate with each other and with the client devices to conduct operations in concert. Examples of the client devices may be smartphones, laptops, tablets, dual-mode cellular phones, wireless Voice-over-Internet Protocol (VOIP) phones, personal digital assistants (e.g., converged devices that support WLAN data and/or voice, and cellular), gaming consoles, wearable devices, or the like.

An STA may refer to any device including end-user devices such as laptops, smartphones, gaming consoles, wearable devices, Internet-of-Things (IoT) devices, or network infrastructure devices such as wireless mesh nodes, which can connect to the WLAN. A STA can either be in a client mode associated with an access point (e.g., any one of the access points 204A-E) or in an access point mode acting as a network provider. When acting as a client device, the STA may connect to an access point (e.g., any one of the access points 204A-E) to gain access to the network. For example, in FIG. 2, the STA may be configured to operate as a client device 206 that may connect to a predetermined number of access points 204A-E. In various embodiments, the client device 206 may connect to the WLAN to utilize services and resources provided by servers, the access points 204A-E, or other network devices. For purposes of illustration, the embodiments shown in FIG. 2 may illustrate a single client device 206 configured to communicate with the access points 204A-E in the wireless environment 200; however, the scope of the present disclosure is not limited to having a single client device 206 communicating with the access points 204A-E in the wireless environment 200, but may extend to include multiple different client devices, for example, enterprise-managed client devices, communicating with the access points 204A-E in the wireless environment 200.

In more embodiments, the wireless environment 200 may be implemented in an enterprise with a large-scale access point deployment. The enterprise may, for example, be a large organization, a campus, an office, a hospital, a warehouse, a conference venue, a shopping mall, any building where the demand for wireless connectively is high and coverage needs to be extensive, or the like. A large-scale access point deployment in an enterprise may refer to an installation and configuration of numerous access points across a broad area or multiple locations within the enterprise to provide comprehensive and reliable wireless network coverage. The embodiments shown in FIG. 2 may illustrate numerous access points 204A-E as part of the wireless environment 200. In additional embodiments, the access points 204A-E may be BLE devices configured to transmit radio signals including data at regular intervals to nearby devices by utilizing, for example, BLE proximity sensing. In further embodiments, each of the access points 204A-E include an integrated BLE radio transmitter configured to transmit BLE beacon signals and to scan and locate other BLE devices, for example, client devices such as smartphones. In still more embodiments, the BLE beacon signals may be picked up by the client device 206 in the wireless environment 200.

In still further embodiments, the BLE beacon signals may be picked up by a locationing application deployed in the client device 206 in the wireless environment 200. In still additional embodiments, the client device 206 may “hear” a BLE beacon signal emitted by one of the access points 204A-E, and the locationing application running on the client device 206 can respond to the recognized BLE beacon signal. BLE scanning may allow the locationing application to listen for and locate all BLE devices, for example, the access points 204A-E. In some more embodiments, the locationing application is implemented on the client device 206 and configured to perform locationing with BLE-assisted UWB two-way ranging through the client device 206. In yet various embodiments, the client device 206 may operate with a BLE gateway, by way of the locationing application, which acts as a bridge between the client device 206 and a network or cloud service (denoted as “location service 208” in FIG. 2). In yet more embodiments, the BLE gateway may facilitate communication and data transfer between the client device 206 and a central system by utilizing one or more network technologies, for example, Wi-Fi, Ethernet, or cellular technologies such as Long Term Evolution (LTE), fifth generation (5G) mobile communication, sixth generation (6G) mobile communication, XG-enabled mobile communication (where XG may refer to any future generation of mobile communication), or the like. In still yet more embodiments, the central system may be a cloud-based system configured to implement the location service 208.

The embodiments shown in FIG. 2 may illustrate numerous access points 204A-E operably coupled to a Wireless Local Area Network (WLAN) controller 202 in the wireless environment 200. In many further embodiments, the WLAN controller 202 may be a computing device configured to manage and control actions of one or more access points, for example, the access points 204A-E, in the WLAN. In many additional embodiments, the Bluetooth-assisted UWB ranging responsibilities of the access points 204A-E, with respect to the client device 206 can be offloaded to the WLAN controller 202. Although the WLAN controller 202 is shown as a single computing device in FIG. 2, the WLAN controller 202 may represent multiple different computing devices either physically located near the access points 204A-E, or physically separate and accessed through one or more networks, for example, the Internet or a cloud.

In still yet further embodiments, each of the access points 204A-E may include, for example, a 16-element directional antenna array configured to transmit unique Radio Frequency (RF) energy in multiple directions to implement virtual BLE. In still yet additional embodiments, a location logic configured to perform locationing with Bluetooth-assisted UWB ranging can be implemented in the access points 204A-E, the client device 206, and/or the WLAN controller 202 to determine a precise location of the client device 206.

Consider an example of locationing an enterprise-managed client device 206 such as a smartphone in a large-scale access point deployment including a predetermined number of access points (e.g., five access points 204A-E). Accordingly, in this example, the client device 206 is paired and bonded to the five virtual BLE access points 204A-E. In several embodiments, the client device 206 may pair with the five virtual BLE access points 204A-E by exchanging security credentials, for example, passkeys or Personal Identification Numbers (PINs) and establishing encryption keys. After pairing, in several more embodiments, the client device 206 may bond with the five virtual BLE access points 204A-E by storing the established encryption keys, thereby ensuring that the client device 206 and the five virtual BLE access points 204A-E can reconnect subsequently without repeating the pairing process.

The locationing application, running on the client device 206, may coordinate the pairing process, in operable communication with an underlying operating system of the client device 206. Once the bonding process is completed, in numerous embodiments, the client device 206 and the access points 204A-E, each may generate long-term keys to authenticate and encrypt future communication between them. The client device 206 may then share these long-term keys with the WLAN controller 202 configured to manage the access points 204A-E. On receiving the long-term keys from the client device 206, the WLAN controller 202 may create a database of bonded client devices.

As the client device 206 travels around a site covered by the access points 204A-E, the locationing application on the client device 206 may perform ranging, for example, dual-sided, two-way ranging over UWB, with the access points 204A-E, in the form of ranging sessions. In various embodiments, the locationing application may perform ranging periodically. In an example scenario as illustrated in FIG. 2, the locationing application on the client device 206 may range with at least three access points during each of these ranging sessions to allow a cloud-based location service 208 to determine a precise physical location of the client device 206 using multilateration. For the sake of brevity, a ranging session of the client device 206 is described with respect to the access points 204A, 204B, and 204E.

In numerous additional embodiments, the locationing application on the client device 206 may configure these ranging sessions over BLE connections with the bonded access points 204A, 204B, and 204E. The BLE connections may facilitate BLE communication between the client device 206 and the access points 204A, 204B, and 204E. When the UWB ranging completes, in further additional embodiments, the locationing application on the client device 206 may transmit the results as ranging data to the cloud-based location service 208. In many embodiments, the ranging data that the client device 206 collects to upload to the cloud-based location service 208 may include a fingerprint that is unique to each of the access points 204A, 204B, and 204E. The fingerprint may allow a ranging engine implemented by the cloud-based location service 208 to determine which physical access point ranged with the client device 206 during a ranging session. In a number of embodiments, the fingerprint may be one of the Media Access Control (MAC) addresses of the access points 204A, 204B, and 204E. In a variety of embodiments, the locationing application on the client device 206 may collect this fingerprint, for example, as a BLE Generic ATTribute (GATT) characteristic.

In this example scenario, the five virtual BLE addresses with which the client device 206 is paired and bonded may roam around the network of access points 204A-E. In various embodiments, the virtual BLE addresses may not be tied to individual access points 204A-E for the roaming function. These bonded virtual BLE addresses may exist virtually and may be configured to the access points 204A-E in the deployment by the WLAN controller 202 along with the database of long-term keys bonded with those virtual BLE addresses. The WLAN controller 202 may execute this configuration to allow the client device 206 to communicate with all the access points including the access points 204A-E in the wireless environment 200 over BLE without having prior knowledge of the existence of each access point. In this example, this configuration allows the client device 206 to perceive the same five known virtual BLE access points 204A-E as available for establishing BLE connections. Periodically, for example, every few minutes, every few hours, or when triggered, the WLAN controller 202 may rotate the five virtual BLE addresses to different access points in the wireless environment 200 to create different clusters of devices. The WLAN controller 202 may rotate these five virtual BLE addresses around the deployment to ensure that the client device 206 operating as a “BLE Central” can see only one instance of each virtual BLE address.

In more embodiments, the WLAN controller 202 may determine the rotation of the virtual BLE addresses within the wireless environment 200 via machine learning to allow these virtual BLE addresses to roam around access points physically located near where the client device 206 was previously located. The machine learning-based determination of the rotation allows generation of higher quality location data of the client device 206 while also freeing up BLE radios to perform other tasks in those areas of the deployment where client devices are not often located.

Although a specific embodiment for a wireless environment 200 showing locationing with Bluetooth-assisted UWB ranging suitable for carrying out the various steps, processes, methods, and operations described herein is discussed with respect to FIG. 2, any of a variety of systems and/or processes may be utilized in accordance with embodiments of the disclosure. For example, the locationing application for executing locationing with Bluetooth-assisted UWB ranging may be configured as a cloud-based application hosted and managed by a service provider and accessed via a network such as the Internet. In another example, the locationing application may be configured as a virtual application hosted on a server and delivered to the client device 206 via a virtual environment. The elements depicted in FIG. 2 may also be interchangeable with other elements of FIG. 1 and FIGS. 3-9 as required to realize a particularly desired embodiment.

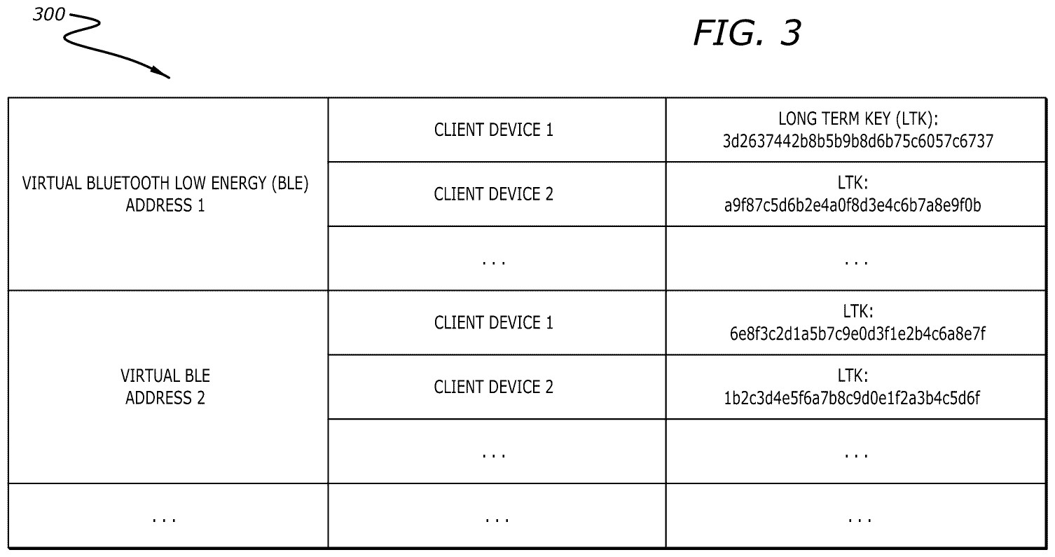

Referring to FIG. 3, a schematic diagram of a conceptual database 300 maintained by a controller of network devices in accordance with various embodiments of the disclosure is shown. The devices and methods discussion herein may utilize virtual BLE addressing with shared long-term keys to allow client devices to autonomously determine their locations. In many embodiments, the controller of the network devices, for example, access points, may create the database 300 of bonded client devices, where a long-term key of each client device may be linked to a virtual BLE address of an access point with which the client device paired and bonded. In a number of embodiments, the database 300 may refer to any storage area or medium that can be used for storing data. In a variety of embodiments, the database 300 can be, for example, any of a structured query language (SQL) data store or a not only SQL (NoSQL) data store such as the Microsoft® SQL Server®, the Oracle® servers, the MySQL® database of MySQL AB Limited Company, the mongoDB® of MongoDB, Inc., the Neo4j graph database of Neo Technology Corporation, the Cassandra database of the Apache Software Foundation, the HBase® database of the Apache Software Foundation, etc. In an embodiment, the database 300 is a location on a file system.

The embodiments shown in FIG. 3 may illustrate the database 300 including, for example, three columns, where a first column may store virtual BLE addresses, a second column may store unique identifiers of client devices that are paired and bonded with each stored virtual BLE address, and a third column may store long-term keys generated and exchanged between the client devices and the corresponding access points associated with the virtual BLE addresses. In various embodiments, the long-term keys may be exchanged between the client devices and the corresponding access points associated with the virtual BLE addresses to authenticate and encrypt future communications therebetween. In an example, a first virtual BLE address 1 associated with a first access point may correspond to two client devices, Client Device 1 and Client Device 2, and their respective long-term keys, in the database 300. Similarly, in this example, a second virtual BLE address 2 associated with a second access point may correspond to the same two client devices, Client Device 1 and Client Device 2, and their respective long-term keys, in the database 300. Though in FIG. 3 it is shown that the first virtual BLE address 1 and the second virtual BLE address 2 correspond to the same client devices, Client Device 1 and Client Device 2, the scope of the disclosure is not limited to it. In further examples, two virtual BLE addresses can correspond to different client devices.

The virtual BLE addresses with which a client device may be paired and bonded may roam or be rotated around a network of access points. In more embodiments, the virtual BLE addresses may not be tied to individual access points for this roaming function. In additional embodiments, these bonded virtual BLE addresses may exist virtually and may be configured to the access points in the deployment by the controller along with the database 300 including the long-term keys bonded with the corresponding virtual BLE address. This configuration may be performed so that the client devices can communicate with all the access points in the network over BLE without having prior knowledge of the existence of each access point, thereby allowing the client device to perceive the same known access points as available for BLE connections. Periodically, for example, every few minutes, the controller may rotate the virtual BLE addresses to other access points to create new clusters of access points. The virtual BLE addresses may be utilized for simulating multiple access points, thereby facilitating the creation of new clusters of access points. In further embodiments, each access point may generate a new BLE address or update its BLE address periodically, for example, at fixed intervals or based on specific events. In still more embodiments, the new BLE addresses may be static, random, or private addresses. In still further embodiments, a single access point may utilize multiple virtual BLE addresses to create multiple advertising profiles or clusters. By rotating these virtual BLE addresses, in still additional embodiments, the access point can change its apparent identity, making the access point reconfigure its role in existing clusters. The access point may transmit advertisements using the new virtual BLE addresses at regular intervals. The controller may rotate the virtual BLE addresses around the access point deployment to ensure that the client device can only see one instance of each virtual BLE address.

Although a specific embodiment for a conceptual database 300 maintained by a controller of network devices suitable for carrying out the various steps, processes, methods, and operations described herein is discussed with respect to FIG. 3, any of a variety of systems and/or processes may be utilized in accordance with embodiments of the disclosure. For example, instead of storing the created database 300 of bonded client devices on a local storage device, the controller may configure the created database 300 as a cloud-based database implemented in a cloud computing environment, where computing resources are delivered as a service over a network. The elements depicted in FIG. 3 may also be interchangeable with other elements of FIGS. 1-2 and FIGS. 4-9 as required to realize a particularly desired embodiment.

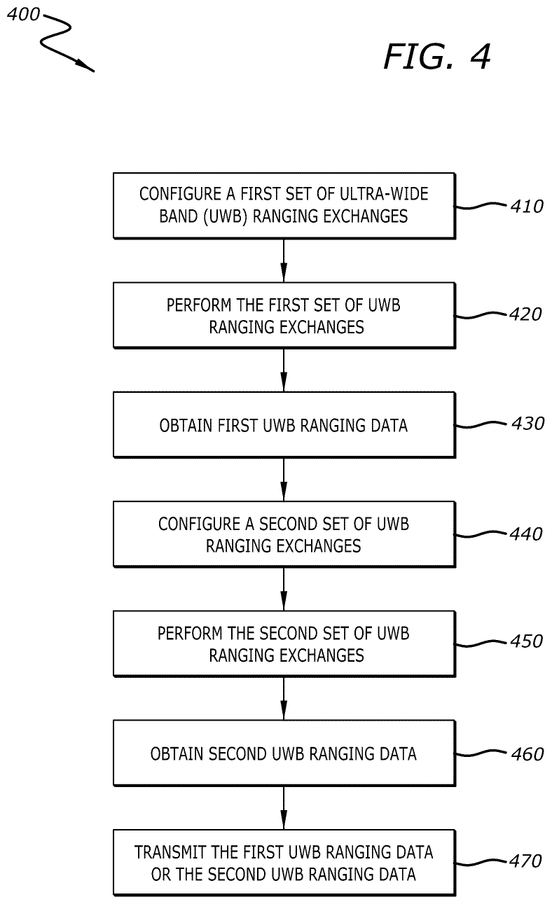

Referring to FIG. 4, a flowchart depicting a process 400 for locationing with multiple rounds of Bluetooth-assisted UWB ranging in accordance with various embodiments of the disclosure is shown. Consider an example for locationing an enterprise-managed client device such as a smartphone in a large-scale access point deployment including a predetermined number of network devices, for example, six network devices. Accordingly, in this example, the client device is paired with and bonded to the six network devices. Once the bonding process is completed, in many embodiments, the client device and the network devices, each may generate long-term keys to authenticate and encrypt future communication therebetween. The client device may then share these long-term keys to a WLAN controller configured to manage the network devices. On receiving the long-term keys from the client device, the WLAN controller may create a database of bonded client devices. As the client device travels around a site covered by the network devices, the locationing application on the client device may periodically perform ranging, for example, dual-sided, two-way ranging over UWB, with the network devices, in the form of ranging sessions herein referred to as “UWB ranging exchanges”. In a number of embodiments, the process 400 may execute multiple rounds of UWB ranging with different sets of network devices configured, for example, as UWB anchors, based on a same set of virtual BLE addresses. In an example as described below, the process 400 may execute two rounds of UWB ranging with two sets of network devices, where each set of network devices may include at least three network devices.

In a variety of embodiments, the process 400 may configure a first set of UWB ranging exchanges (block 410). The process 400 may configure the first set of UWB ranging exchanges associated with a first set of network devices. In the above example scenario, the first set of network devices may include at least three network devices. The configuration may be performed on the client device and may include setting up the client device to communicate with the first set of network devices for measuring distance between them. In various embodiments, the first set of network devices may be a first set of access points with which the client device ranges. In more embodiments, the first set of UWB ranging exchanges between the client device and the first set of network devices may include time-based distance determination measurements, for example, a time of flight (ToF) and time-difference of arrival (TDoA) measurements. In additional embodiments, the configuration of the first set of UWB ranging exchanges may include ensuring that the client device and the first set of network devices are synchronized to the same time base for increasing the accuracy of the ToF and TDoA measurements. In further embodiments, the configuration of the first set of UWB ranging exchanges may further include selecting a channel, for example, a BLE OOB channel, based on which a BLE connection is made between the client device and each of the network devices in the first set. In still more embodiments, the configuration of the first set of UWB ranging exchanges may further include selecting a ranging mode, for example, two-way ranging, where the client device and each of the network devices in the first set transmit and receive UWB RF signals. In still further embodiments, the configuration of the first set of UWB ranging exchanges may further include setting the number of rounds of UWB ranging. In still additional embodiments, the configuration of the first set of UWB ranging exchanges may further include configuring a frame structure for UWB transmissions during the first set of UWB ranging exchanges.

In some more embodiments, the process 400 may configure the first set of UWB ranging exchanges associated with the first set of network devices based on at least a part of bonding data associated with multiple virtual Bluetooth addresses. The virtual Bluetooth addresses may, for example, include virtual BLE addresses. In yet various embodiments, the bonding data may include the long-term keys generated by the client device and each of the network devices in the first set, after bonding is completed. In yet more embodiments, the process 400 may retrieve the bonding data associated with multiple virtual Bluetooth addresses from the database of bonded client devices created by the WLAN controller.

In still yet more embodiments, the process 400 may perform the first set of UWB ranging exchanges (block 420). In the above example scenario, the client device may range with at least three network devices and accordingly execute at least three UWB ranging exchanges so that the precise physical location of the client device can be determined by the cloud using multilateration. The process 400 may perform the first set of UWB ranging exchanges based on the configuration executed by the client device. For example, based on the selection of a BLE OOB channel, the process 400 may establish a BLE connection between the client device and each of the network devices in the first set. In another example, based on the selection of a two-way ranging mode, the process 400 may allow transmission and reception of UWB RF signals between the client device and each of the network devices in the first set. In many further embodiments, the two-way ranging over UWB may include, for example, ToF, Time-of-Arrival (ToA), TDoA, Received Signal Strength Indicator (RSSI), and/or other analyses of UWB transmissions. During two-way ranging such as dual-sided two-way ranging over UWB, the process 400 may periodically perform the first set of UWB ranging exchanges between the client device and the first set of network devices. The first set of UWB ranging exchanges may be two-way UWB ranging exchanges. In many additional embodiments, these UWB ranging exchanges may be configured over the BLE connections with the bonded network devices in the first set.

In still yet further embodiments, the process 400 may obtain first UWB ranging data (block 430). In still yet additional embodiments, the process 400 may obtain first UWB ranging data based on the first set of UWB ranging exchanges. In several embodiments, the first UWB ranging data may include, for example, ToF measurements such as roundtrip time and time stamps, signal transmission and reception information such as time stamps, transmit time, receive time, response time, final receive time, ranging data packet information, or the like. In further examples, the first UWB ranging data may include clock drift corrections, environmental corrections, calculated distances, accuracy and precision metrics, device identifiers, and metadata related to the UWB ranging exchanges. In several more embodiments, the first UWB ranging data may include first fingerprint data associated with the first set of network devices. The first fingerprint data may include a fingerprint, that is, a unique identifier or signature, configured to uniquely identify each of the network devices in the first set. In numerous embodiments, the first fingerprint data may include a first set of MAC addresses for the first set of network devices. The first fingerprint data may be obtained by the client device from each of the network devices in the first set. In numerous additional embodiments, the first fingerprint data may be obtained from each of the network devices in the first set via a set of Bluetooth communications.

In further additional embodiments, the process 400 may configure a second set of UWB ranging exchanges (block 440). The process 400 may configure the second set of UWB ranging exchanges associated with a second set of network devices. In the above example scenario, the second set of network devices may include at least three network devices. The configuration may be performed on the client device and may include setting up the client device to communicate with the second set of network devices for measuring distance between them. In many embodiments, the second set of network devices may be a second set of access points with which the client device ranges. In a number of embodiments, the second set of UWB ranging exchanges between the client device and the second set of network devices may include time-based distance determination measurements, for example, ToF and TDoA measurements. In a variety of embodiments, the configuration of the second set of UWB ranging exchanges may include ensuring that the client device and the second set of network devices are synchronized to the same time base for increasing the accuracy of the ToF and TDoA measurements. In various embodiments, the configuration of the second set of UWB ranging exchanges may further include selecting a channel, for example, a BLE OOB channel, based on which a BLE connection is made between the client device and each of the network devices in the second set. In more embodiments, the configuration of the second set of UWB ranging exchanges may further include selecting a ranging mode, for example, two-way ranging, where the client device and each of the network devices in the second set transmit and receive UWB RF signals. In additional embodiments, the configuration of the second set of UWB ranging exchanges may further include setting the number of rounds of UWB ranging. In further embodiments, the configuration of the second set of UWB ranging exchanges may further include configuring a frame structure for UWB transmissions during the second set of UWB ranging exchanges.

In still more embodiments, the process 400 may configure the second set of UWB ranging exchanges associated with the second set of network devices based on at least a part of bonding data associated with the same virtual Bluetooth addresses. The virtual Bluetooth addresses may, for example, include virtual BLE addresses. In still further embodiments, the bonding data may include the long-term keys generated by the client device and each of the network devices in the second set, after bonding is completed. In still additional embodiments, the process 400 may retrieve the bonding data associated with multiple virtual Bluetooth addresses from the database of bonded client devices created by the WLAN controller.

In some more embodiments, the process 400 may perform the second set of UWB ranging exchanges (block 450). In the above example scenario, the client device may range with at least three network devices in the second set of network devices and accordingly execute at least three UWB ranging exchanges so that the precise physical location of the client device can be determined by the cloud using multilateration. The process 400 may perform the second set of UWB ranging exchanges based on the configuration executed by the client device. For example, based on the selection of a BLE OOB channel, the process 400 may establish a BLE connection between the client device and each of the network devices in the second set. In another example, based on the selection of a two-way ranging mode, the process 400 may allow transmission and reception of UWB RF signals between the client device and each of the network devices in the second set. In yet various embodiments, the two-way ranging over UWB may include, for example, ToF, ToA, TDoA, RSSI, and/or other analyses of UWB transmissions. During two-way ranging such as dual-sided two-way ranging over UWB, the process 400 may periodically perform the second set of UWB ranging exchanges between the client device and the second set of network devices. The second set of UWB ranging exchanges may be two-way UWB ranging exchanges. In yet more embodiments, these UWB ranging exchanges may be configured over the BLE connections with the bonded network devices in the second set.

In still yet more embodiments, the process 400 may obtain second UWB ranging data (block 460). In many further embodiments, the process 400 may obtain second UWB ranging data based on the second set of UWB ranging exchanges. In many additional embodiments, the second UWB ranging data may include, for example, ToF measurements such as roundtrip time and time stamps, signal transmission and reception information such as time stamps, transmit time, receive time, response time, final receive time, ranging data packet information, or the like. In further examples, the second UWB ranging data may include clock drift corrections, environmental corrections, calculated distances, accuracy and precision metrics, device identifiers, and metadata related to the UWB ranging exchanges. In still yet further embodiments, the second UWB ranging data may include second fingerprint data associated with the second set of network devices. The second fingerprint data may include a fingerprint, that is, a unique identifier or signature, configured to uniquely identify each of the network devices in the second set. In still yet additional embodiments, the second fingerprint data may include a second set of MAC addresses for the second set of network devices. The second fingerprint data may be obtained by the client device from each of the network devices in the second set. In several embodiments, the second fingerprint data may be obtained from each of the network devices in the second set via a set of Bluetooth communications.

In several more embodiments, a first network device in the first set of network devices and a second network device in the second set of network devices may be different network devices. A first UWB ranging exchange in the first set of UWB ranging exchanges may be configured with the first network device based on bonding data associated with a virtual Bluetooth address among the virtual Bluetooth addresses. A second UWB ranging exchange in the second set of UWB ranging exchanges may be configured with the second network device based on the bonding data associated with the same virtual Bluetooth address. The virtual Bluetooth address may, for example, be a virtual BLE address. In other words, though the physical network devices in the first and second sets can be different, one or more virtual Bluetooth addresses utilized in the first set can be the same as one or more virtual Bluetooth addresses utilized in the second set. Periodically, on a scale of every few minutes or every few hours, or when triggered by an event, the WLAN controller may rotate the virtual BLE addresses to new network devices to create new clusters of network devices. Rotating these virtual BLE addresses around the deployment may be performed to ensure that the client device can only see one instance of each virtual BLE address.

In numerous embodiments, the process 400 may transmit the first UWB ranging data or the second UWB ranging data (block 470). In numerous additional embodiments, the process 400 may transmit the obtained first UWB ranging data to a cloud for processing. In further additional embodiments, the process 400 may transmit the first fingerprint data as part of the first UWB ranging data to the cloud for processing. In many embodiments, the process 400 may transmit the obtained second UWB ranging data to a cloud for processing. In a number of embodiments, the process 400 may transmit the second fingerprint data as part of the second UWB ranging data to the cloud for processing. The processing may include precise determination of the location of the client device. In a variety of embodiments, a first location determination for the client device may be performed based on the first UWB ranging data and the first fingerprint data. In various embodiments, a second location determination for the client device may be performed based on the second UWB ranging data and the second fingerprint data. For example, the cloud may process the first UWB ranging data and/or the second UWB ranging data which may include ToF measurements to calculate the exact distance between the client device and each of the network devices in the first set and/or the second set. In the above example scenario, the cloud may employ triangulation or trilateration algorithms to determine the location of the client device. In more embodiments, one or more of the first UWB ranging data, the first fingerprint data, the second UWB ranging data, or the second fingerprint data are transmitted to a network device in the first set or the second set, and the first location determination or the second location determination is received from the network device.

Although a specific embodiment for a process 400 for locationing with multiple rounds of Bluetooth-assisted UWB ranging suitable for carrying out the various steps, processes, methods, and operations described herein is discussed with respect to FIG. 4, any of a variety of systems and/or processes may be utilized in accordance with various embodiments of the disclosure. For example, the WLAN controller associated with the first set of network devices and the second set of network devices can determine a respective UWB ranging priority and schedule for ranging with the client device based on one or more attributes such as a field indicating a relative priority, a device type, a use case, a required ranging interval, or the like. The elements depicted in FIG. 4 may also be interchangeable with other elements of FIGS. 1-3 and FIGS. 5-9 as required to realize a particularly desired embodiment.

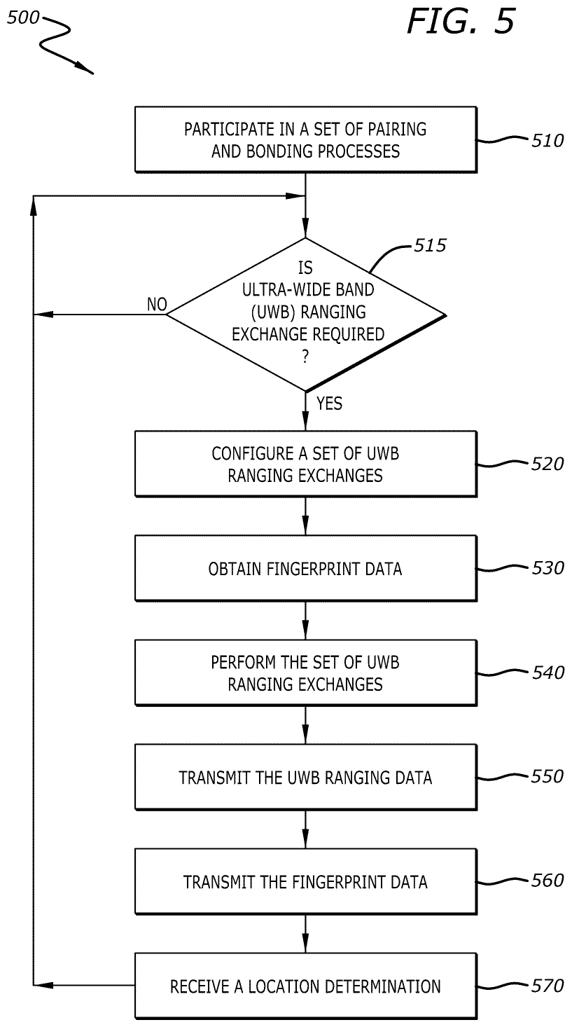

Referring to FIG. 5, a flowchart depicting a process 500 for locationing with a single round of Bluetooth-assisted UWB ranging in accordance with various embodiments of the disclosure is shown. Consider an example for locationing an enterprise-managed client device such as a smartphone in a large-scale access point deployment including a predetermined number of network devices, for example, six network devices.

In many embodiments, the process 500 may participate in a set of pairing and bonding processes (block 510). In a number of embodiments, the process 500 may participate in the set of pairing and bonding processes associated with multiple virtual Bluetooth addresses, for example, virtual BLE addresses. In the above example, the process 500 may participate in the set of pairing and bonding processes with six virtual BLE addresses corresponding to the six network devices. The six virtual BLE addresses with which the client device may be paired and bonded may roam around a site including the six network devices and many other network devices. In a variety of embodiments, the virtual BLE addresses may not be tied to individual network devices for the roaming function. These bonded virtual BLE addresses may exist virtually and may be configured to the network devices in the deployment by the controller along with the database of long-term keys bonded with those virtual BLE addresses. The controller may execute this configuration to allow the client device to communicate with all the network devices in the network over BLE without having prior knowledge of the existence of each network device. This configuration allows the client device to perceive the same six known network devices as available for establishing BLE connections. In various embodiments, for each virtual BLE address in the plurality of virtual Bluetooth addresses, a long-term key may be generated during a respective pairing and bonding process in the set of pairing and bonding processes.

In more embodiments, the process 500 may execute BLE pairing and bonding processes between the client and each of the network devices as follows. The BLE pairing process may include an exchange of information necessary to establish an encrypted BLE connection between the client device and each of the network devices. In additional embodiments, the BLE pairing process may include authenticating the identity of the two devices to be paired, encrypting a communication link between the two devices, and sharing security keys on the encrypted communication link. In further embodiments, the BLE pairing process may include a pairing feature exchange where the client device may send a pairing request to each of the network devices, which may reply thereto with a pairing response. The pairing request and the pairing response may include data packets that contain details about features and capabilities of each device. The client device and each of the network devices can collectively determine the most suitable pairing method for generation of the security keys by examining Secure Connections (SC), OOB, Man In The Middle (MITM) protection, and Input/Output (I/O) capability fields in the data packets. In still more embodiments, the key generation process may execute LE legacy pairing or LE secure connections methods for generating the security keys.

In still further embodiments, an encryption key may be generated for encrypting the communication link between the client device and each of the network devices. The client device and each of the network devices can then share their security keys on the encrypted communication link. After pairing, the client device may choose to undergo a BLE bonding process with each of the network devices. In still additional embodiments, the BLE bonding process may include storing security information exchanged during a successful pairing of the client device with each of the network devices, thereby allowing the devices to reconnect automatically without having to pair again. In some more embodiments, during the bonding processes, the process 500 may generate bonding data. In yet various embodiments, the bonding data associated with the plurality of virtual Bluetooth addresses may include, for each virtual Bluetooth address, the generated long-term key. In yet more embodiments, the bonding data associated with the plurality of virtual Bluetooth addresses may be stored during the set of pairing and bonding processes.

In still yet more embodiments, the process 500 may determine whether a UWB ranging exchange is required (block 515). The client device may need to determine whether a UWB ranging exchange is required for optimizing performance, conserving resources, and ensuring accurate locationing. A UWB ranging exchange may involve power-intensive ranging operations and resource-intensive processing and communication operations. By determining whether a UWB ranging exchange is required, the process 500 can minimize unnecessary ranging operations, thereby conserving battery life, managing computational resources, and extending operational time of the client device. By determining when a UWB ranging exchange is genuinely needed, the client device may assist in reducing network traffic and improving overall system efficiency. Efficient use of UWB ranging exchanges may optimize the communication bandwidth and reduce potential collisions or interference in the UWB network. In various embodiments, UWB ranging exchange may be required to be performed at periodic intervals. In such embodiments, the process 500 may determine whether the scheduled time instance for performing the UWB ranging exchange has arrived or not.

In many further embodiments, in response to determining that the UWB ranging exchange is required, the process 500 may configure a set of UWB ranging exchanges (block 520). The process 500 may configure the set of UWB ranging exchanges associated with a set of network devices. In many additional embodiments, the set of network devices may be configured, for example, as UWB anchors. Continuing the above example scenario, the set of network devices may include at least three network devices from among the six network devices in a large-scale deployment of an enterprise. The configuration may be performed on the client device and may include setting up the client device to communicate with the set of network devices for measuring distance between them. In still yet further embodiments, the set of network devices may be a set of access points with which the client device ranges. In still yet additional embodiments, the set of UWB ranging exchanges between the client device and the set of network devices may include time-based distance determination measurements, for example, ToF and TDoA measurements.

In several embodiments, the configuration of the set of UWB ranging exchanges may include ensuring that the client device and the set of network devices are synchronized to the same time base for increasing the accuracy of the ToF and TDoA measurements. In several more embodiments, the configuration of the set of UWB ranging exchanges may further include selecting a channel, for example, a BLE OOB channel, based on which a BLE connection is made between the client device and each of the network devices in the set. In numerous embodiments, the configuration of the set of UWB ranging exchanges may further include selecting a ranging mode, for example, two-way ranging, where the client device and each of the network devices in the set transmit and receive UWB RF signals. In numerous additional embodiments, the configuration of the set of UWB ranging exchanges may further include setting the number of rounds of UWB ranging. In the above example scenario, the process 500 may select a single round of UWB ranging between the client device and each of the network devices in the set. In further additional embodiments, the configuration of the set of UWB ranging exchanges may further include configuring a frame structure for UWB transmissions during the first set of UWB ranging exchanges.

In many embodiments, the process 500 may configure the set of UWB ranging exchanges associated with the set of network devices based on at least a part of bonding data associated with multiple virtual Bluetooth addresses. The virtual Bluetooth addresses may, for example, include virtual BLE addresses. In a number of embodiments, the bonding data may include the long-term keys generated by the client device and each of the network devices in the set, after bonding is completed. In a variety of embodiments, the process 500 may retrieve the bonding data associated with multiple virtual Bluetooth addresses from the database of bonded client devices created by the WLAN controller.

In various embodiments, the process 500 may obtain fingerprint data (block 530). In more embodiments, the process 500 may obtain the fingerprint data from the set of network devices. The fingerprint data may form a part of the ranging data collected by the client device from each of the network devices during the UWB ranging exchanges. The fingerprint data may include a fingerprint, that is, a unique identifier or signature, configured to uniquely identify each of the network devices. In additional embodiments, the unique identifier may utilize the same data format as a conventional UWB anchor that may include, for example, a universally unique identifier that distinguishes a network device from other network devices in the large-scale deployment of the enterprise.

In further embodiments, the process 500 may perform the set of UWB ranging exchanges (block 540). As the client device travels around a site covered by the network devices, the locationing application on the client device may periodically perform ranging, for example, dual-sided, two-way ranging over UWB, with the network devices, in the form of ranging sessions herein referred to as “UWB ranging exchanges”. In still more embodiments, the process 500 may execute a single round of UWB ranging with one set of network devices based on virtual BLE addresses. For example, the process 500 may execute a single round of UWB ranging with at least three network devices from among the six network devices in the large-scale deployment.

In the above example scenario, the client device may range with at least three network devices and accordingly execute at least three UWB ranging exchanges so that the precise physical location of the client device can be determined by the cloud using multilateration. The process 500 may perform the set of UWB ranging exchanges based on the configuration executed by the client device. For example, based on the selection of a BLE OOB channel, the process 500 may establish a BLE connection between the client device and each of the network devices in the set. In another example, based on the selection of a two-way ranging mode, the process 500 may allow transmission and reception of UWB RF signals between the client device and each of the network devices in the set. In still further embodiments, the two-way ranging over UWB may include, for example, ToF, ToA, TDoA, RSSI, and/or other analyses of UWB transmissions. During two-way ranging such as dual-sided two-way ranging over UWB, the process 500 may periodically perform the set of UWB ranging exchanges between the client device and the set of network devices. The set of UWB ranging exchanges may be two-way UWB ranging exchanges. In still additional embodiments, these UWB ranging exchanges may be configured over the BLE connections with the bonded network devices in the set.

In some more embodiments, the process 500 may transmit the UWB ranging data (block 550). In yet various embodiments, the process 500 may transmit the UWB ranging data based on the set of UWB ranging exchanges. In yet more embodiments, the UWB ranging data may include, for example, ToF measurements such as roundtrip time and time stamps, signal transmission and reception information such as time stamps, transmit time, receive time, response time, final receive time, ranging data packet information, or the like. In further examples, the UWB ranging data may include clock drift corrections, environmental corrections, calculated distances, accuracy and precision metrics, device identifiers, and metadata related to the UWB ranging exchanges. In still yet more embodiments, the process 500 may transmit the UWB ranging data to a cloud configured to execute a location service.

In many further embodiments, the process 500 may transmit the fingerprint data (block 560). As a part of the UWB ranging data that the client device may collect to upload to the cloud, the process 500 may transmit the obtained fingerprint data associated with each of the network devices in the set. The obtained fingerprint data may include the fingerprint that is unique to each network device. In many additional embodiments, this fingerprint can be one of the MAC addresses of the network devices and may be collected by the locationing application on the client device as a BLE Generic ATTribute (GATT) characteristic. In still yet further embodiments, the process 500 may transmit the fingerprint data to the cloud to allow a ranging engine in the cloud to determine which physical network device ranged with the client device during each UWB ranging exchange.

In still yet additional embodiments, the process 500 may receive a location determination (block 570) and proceed to determine whether a UWB ranging exchange is required (block 515) as described above. In several embodiments, the process 500 may receive the location determination based on the UWB ranging data and the fingerprint data. In several more embodiments, the process 500 may receive the location determination from the ranging engine in the cloud. The location of the client device may be determined based on the ranging data and the printed data transmitted to the cloud by the client device. In numerous embodiments, the precise physical location of the client device can be determined by the cloud using multilateration. In the above example scenario including three UWB exchanges with three network devices, the precise physical location of the client device can be determined by the cloud using trilateration.

However, in numerous additional embodiments, in response to determining that the UWB ranging exchange is not required, the process 500 may proceed to determine whether a UWB ranging exchange is required (block 515) as described above. In further additional embodiments, the UWB ranging exchanges may not be required when the required precision of location determination is relatively low. In many embodiments, the UWB ranging exchanges may not be required when the location can be determined by utilizing low-power technologies. Precluding UWB ranging exchanges, when not required, may allow minimization of unnecessary ranging operations, thereby conserving battery life, managing computational resources, and extending operational time of the client device.

Although a specific embodiment for a process 500 for locationing with a single round of Bluetooth-assisted UWB ranging suitable for carrying out the various steps, processes, methods, and operations described herein is discussed with respect to FIG. 5, any of a variety of systems and/or processes may be utilized in accordance with embodiments of the disclosure. For example, other than multilateration, the precise physical location of the client device can be determined according to one or more other algorithms including a distance function, trilateration function, a triangulation function, a fingerprinting function, a differential function, a ToF function, a ToA function, a TDoA function, an AoA function, an angle of departure function, a geometric function, etc., or any combination thereof. The elements depicted in FIG. 5 may also be interchangeable with other elements of FIGS. 1-4 and FIGS. 6-9 as required to realize a particularly desired embodiment.

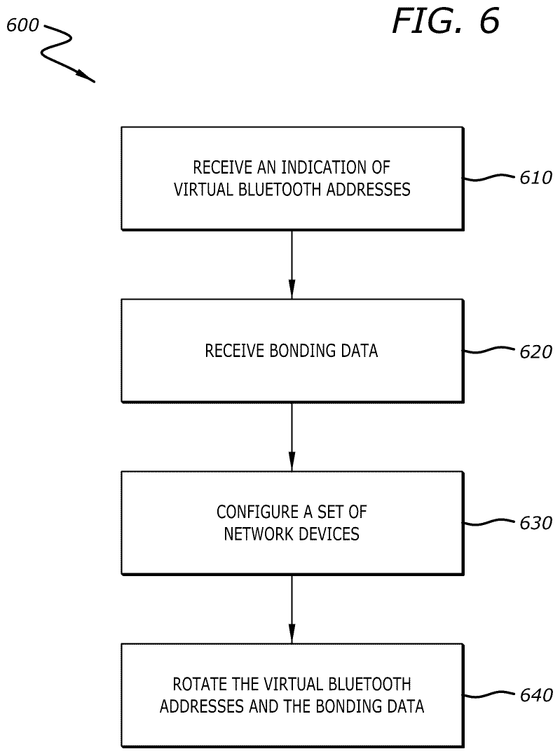

Referring to FIG. 6, a flowchart depicting a process 600 for configuring a plurality of network devices with virtual BLE addresses in accordance with various embodiments of the disclosure is shown. The network devices may be BLE access points. In many embodiments, a WLAN controller may be deployed in a wireless environment where multiple network devices are implemented to execute ranging, for example, dual-sided two-way ranging over UWB, with a client device such as a smartphone. In a number of embodiments, the plurality of network devices is under management by the WLAN controller. The WLAN controller may configure each of the network devices with virtual Bluetooth addresses.

In a variety of embodiments, the process 600 may receive an indication of virtual Bluetooth addresses (block 610). In an example, the virtual Bluetooth addresses may include virtual BLE addresses. The virtual BLE addresses may not be tied to a specific network device but may be utilized to represent different virtual identities or services. The virtual BLE addresses may allow a network device to simulate multiple BLE network devices or roles. In various embodiments, the virtual BLE addresses may be assigned to a network device manually if the network device supports static address configuration. In more embodiments, the virtual BLE addresses may be assigned dynamically to a network device based on different conditions or policies. In additional embodiments, the indication of the virtual BLE addresses may be received from advertisements broadcasted by the network devices deployed in the wireless environment. In further embodiments, the indication of the virtual BLE addresses may be received by the WLAN controller from the network devices. The WLAN controller may be configured to create a database of bonded client devices. In still more embodiments, each of the network devices in the wireless environment may be associated with a virtual BLE address. When a client device pairs with and bonds to a network device, its bonding data may include a unique identifier of the client device and the virtual BLE address associated with the network device to which the client device bonded. In still further embodiments, the bonding data may further include the long-term keys generated by the client device and the network device. The client device may transmit the bonding data to the WLAN controller. Similarly, the client device may transmit the bonding data associated with each of the network devices to which the client device bonded, to the WLAN controller.

In still additional embodiments, the process 600 may receive the bonding data (block 620). In some more embodiments, the bonding data may be associated with multiple virtual Bluetooth addresses, for example, virtual BLE addresses. The bonding data associated with the virtual Bluetooth addresses may include a long-term key for each pair including a virtual Bluetooth address and a client device. In yet various embodiments, the bonding data may further be associated with one or more client devices. In yet more embodiments, the process 600 may receive the bonding data via Bluetooth communications with the client device and/or the network devices. In yet more embodiments, the bonding data may be received by the WLAN controller. The received bonding data may include, for example, the unique identifier of the client device, the virtual BLE addresses associated with the network devices to which the client device bonded, and the long-term keys generated by the client device and the network devices. In still yet more embodiments, the WLAN controller may store the virtual BLE addresses and the bonding data in a datastore.

In many further embodiments, the process 600 may configure a set of network devices (block 630). In many additional embodiments, the process 600 may configure a set of network devices, for example, at least three network devices from among multiple network devices in the wireless environment. In still yet further embodiments, the process 600 may configure the set of network devices with the virtual Bluetooth addresses and the bonding data. In still yet additional embodiments, the virtual BLE addresses with which the client device may be paired and bonded may roam around the network devices in the wireless environment. In still yet additional embodiments, the virtual BLE addresses are not tied to individual network devices for this roaming function. In several embodiments, the roaming function may be performed similar to roaming based on RSSI. These bonded virtual BLE addresses may exist virtually and may be configured to the network devices in the deployment by the WLAN controller along with the database of long-term keys bonded with those virtual BLE addresses. In several more embodiments, the process 600 may execute this configuration to allow the client device to communicate with all the network devices in the wireless environment over BLE without even having prior knowledge of a network device's existence. The client device may, therefore, perceive the same known set of network devices.

Roaming in the context of BLE may refer to the ability of the client device to move from one physical location to another while maintaining a connection or seamless interaction with BLE services. For virtual BLE addresses, this means maintaining consistency in service access and client interactions despite changes in the physical network device. The network device may utilize virtual BLE addresses to advertise different services or identities. As the client device moves, the WLAN controller may utilize these virtual BLE addresses to ensure that the client device continues to receive the same services or data regardless of the physical network device with which the client device interacts. The virtual BLE addresses may be mapped to specific physical locations or services. When the client device moves, the WLAN controller may map the virtual BLE address to the nearest or most appropriate physical network device.

In environments with multiple network devices, for example, a large-scale access point deployment in an enterprise, roaming allows the client device to seamlessly transition between different network devices while maintaining the same virtual BLE address. For example, in a large building with multiple network devices, the client device moving from one area to another area may connect to different network devices but still access the same virtual services or data. When roaming, the WLAN controller may manage sessions to ensure that connections and interactions of the client device with the virtual BLE addresses are maintained. This session management may involve session handovers or re-establishing connections to the appropriate virtual BLE address as the client device moves. The client device that supports roaming may handle reconnections to the appropriate virtual BLE address as the client device moves through different areas covered by the network devices. The WLAN controller may ensure that the client device continues to interact with the same virtual identity or service, providing a seamless user experience.

In numerous embodiments, the process 600 may rotate the virtual Bluetooth addresses and the bonding data (block 640). In numerous additional embodiments, the process 600 may rotate the virtual Bluetooth addresses and the bonding data to additional network devices in the plurality of network devices deployed in the wireless environment. Rotation may involve periodically changing or cycling through the virtual BLE addresses that are broadcasted or used for different services, which may assist in ensuring that BLE services remain available across different physical locations or contexts. The process 600 may periodically rotate the virtual BLE addresses to new network devices to create new clusters of network devices. The process 600 may rotate these virtual BLE addresses around the deployment to ensure that the client device (acting as a BLE central) can only perceive one instance of each virtual BLE address at any given time. In further additional embodiments, the process 600 may be configured to rotate the virtual BLE addresses at regular intervals or at certain specific events. For example, the WLAN controller may change the virtual BLE address every few minutes or hours based on a schedule. In many embodiments, the process 600 may rotate the plurality of virtual BLE addresses and the bonding data based on historical client device location data to allow these virtual BLE addresses to more often roam around the network devices physically located near where the client device was previously located.

In a number of embodiments, the process 600 may rotate the plurality of virtual Bluetooth addresses and the bonding data based on a machine learning process. In a variety of embodiments, the process 600 may determine the rotation of the virtual BLE addresses within the wireless environment via machine learning. In these embodiments, the WLAN controller may rotate the virtual BLE addresses such that the virtual BLE addresses more often roam around the network devices physically located near where the client device was previously located, thereby generating higher quality location data while freeing up the network devices with BLE radios to perform other tasks in those areas of the deployment where client devices may not be located often. In more embodiments, in addition to the rotation of the virtual BLE addresses, the process 600 may further rotate a part of the bonding data, for example, the long-term keys, corresponding to the virtual BLE addresses as stored in the database of bonded client devices. In other words, along with rotation of a virtual BLE address, the WLAN controller may rotate the long-term keys shared by the client device and the network device associated with the virtual BLE address.

Although a specific embodiment for a process 600 for configuring a plurality of network devices with virtual BLE addresses suitable for carrying out the various steps, processes, methods, and operations described herein is discussed with respect to FIG. 6, any of a variety of systems and/or processes may be utilized in accordance with embodiments of the disclosure. For example, the network devices may provide Application Programming Interfaces (APIs) or Simple Network Management Protocol (SNMP) interfaces to allow the WLAN controller to retrieve and manage the bonding data programmatically. In another example, the bonding data collected from various networking devices can be forwarded to a central server or a network management system for aggregation and analysis. The elements depicted in FIG. 6 may also be interchangeable with other elements of FIGS. 1-5 and FIGS. 7-9 as required to realize a particularly desired embodiment.

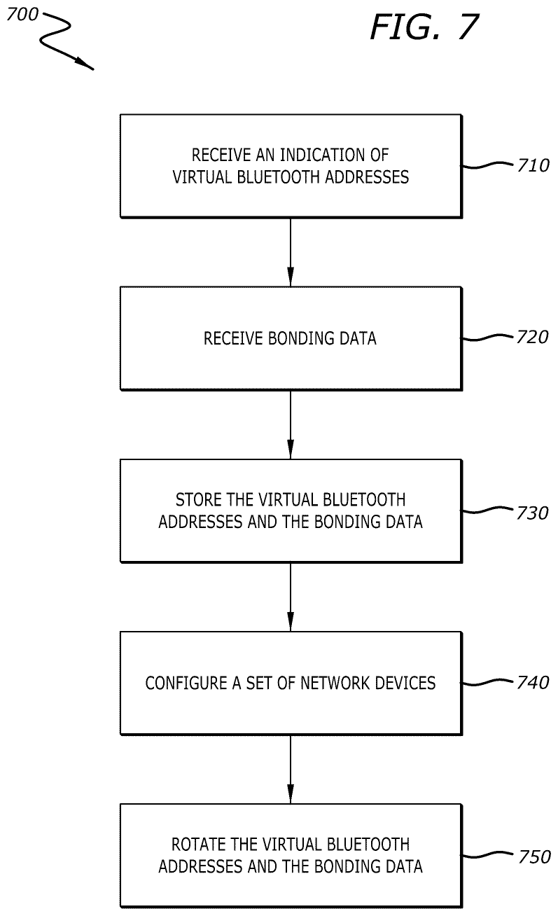

Referring to FIG. 7, a flowchart depicting a process 700 for configuring a plurality of network devices with virtual BLE addresses in accordance with various embodiments of the disclosure is shown. In many embodiments, a WLAN controller may be deployed in a wireless environment where multiple network devices, for example, BLE access points, are implemented to execute dual-sided two-way ranging over UWB, with a client device such as a smartphone. The WLAN controller may configure each of the network devices with virtual Bluetooth addresses.

In a number of embodiments, the process 700 may receive an indication of virtual Bluetooth addresses (block 710). In an example, the virtual Bluetooth addresses may be virtual BLE addresses. The virtual BLE addresses may not be tied to a specific network device but may be utilized to represent different virtual identities or services. In a variety of embodiments, the indication of the virtual BLE addresses may be received from advertisements broadcasted by the network devices deployed in the wireless environment. In various embodiments, the indication of the virtual BLE addresses may be received by the WLAN controller from the network devices. In more embodiments, each of the network devices in the wireless environment may be associated with a virtual BLE address. When a client device pairs with and bonds to a network device, its bonding data may include a unique identifier of the client device and the virtual BLE address associated with the network device to which the client device bonded. In additional embodiments, the bonding data may further include the long-term keys generated by the client device and the network device. The client device may transmit the bonding data to the WLAN controller. Similarly, the client device may transmit the bonding data associated with each of the network devices to which the client device bonded, to the WLAN controller.

In further embodiments, the process 700 may receive bonding data (block 720). In still more embodiments, the process 700 may receive the bonding data via Bluetooth communications with the client device and/or the network devices. In still further embodiments, the process 700 may receive the bonding data via Bluetooth communications with the client device and/or the network devices. In still additional embodiments, the bonding data may be received by the WLAN controller. The received bonding data may include, for example, the unique identifier of the client device, the virtual BLE address associated with the network device to which the client device bonded, and the long-term keys generated by the client device and the network device.

In some more embodiments, the process 700 may store the virtual Bluetooth addresses and the bonding data (block 730). In yet various embodiments, the process 700 may create a database of bonded client devices for storing the virtual Bluetooth addresses and the bonding data. In yet more embodiments, the database of bonded client devices may be created by the WLAN controller. On receiving the bonding data from the WLAN controller, the WLAN controller may store the bonding data in the database of bonded client devices. The database of bonded client devices may include columns for storing, for example: the virtual BLE addresses, unique identifiers of client devices bonded to the network devices associated with the virtual BLE addresses, and the long-term keys generated and shared by the client devices and the network devices.

In still yet more embodiments, the process 700 may configure a set of network devices (block 740). In many further embodiments, the virtual BLE addresses with which the client device may be paired and bonded may roam (for example, be rotated) around the network devices in the wireless environment. In many additional embodiments, the virtual BLE addresses are not tied to individual network devices for this roaming function. In still yet further embodiments, the roaming function may be performed similar to roaming based on RSSI. These bonded virtual BLE addresses may exist virtually and may be configured to the network devices in the deployment by the WLAN controller along with the database of long-term keys bonded with those virtual BLE addresses. In still yet additional embodiments, the process 700 may execute this configuration to allow the client device to communicate with all the network devices in the wireless environment over BLE without even having prior knowledge of a network device's existence. The client device may, therefore, perceive the same known set of network devices.

In several embodiments, the process 700 may rotate the virtual Bluetooth addresses and the bonding data (block 750). Rotation may involve periodically changing or cycling through the virtual BLE addresses that are broadcasted or used for different services, which may assist in ensuring that BLE services remain available across different physical locations or contexts. The process 700 may periodically or upon a trigger rotate the virtual BLE addresses to new network devices to create new clusters of network devices. The process 700 may rotate these virtual BLE addresses around the deployment to ensure that the client device (acting as a BLE central) can only perceive one instance of each virtual BLE address at any given time. In several more embodiments, the process 700 may be configured to rotate the virtual BLE addresses at regular intervals. For example, the WLAN controller may change the virtual BLE address every few minutes or hours based on a schedule. In numerous embodiments, the process 700 may determine the rotation of the virtual BLE addresses within the wireless environment via machine learning. In these embodiments, the WLAN controller may rotate the virtual BLE addresses such that the virtual BLE addresses more often roam around the network devices physically located near where the client device was previously located, thereby generating higher quality location data while freeing up the network devices with BLE radios to perform other tasks in those areas of the deployment where client devices may not be located often. In numerous additional embodiments, in addition to the rotation of the virtual BLE addresses, the process 700 may further rotate a part of the bonding data, for example, the long-term keys, corresponding to the virtual BLE addresses as stored in the database of bonded client devices. Along with rotation of a virtual BLE address, the WLAN controller may rotate the long-term keys shared by the client device and the network device associated with the virtual BLE address.

Although a specific embodiment for a process 700 for configuring a plurality of network devices with virtual BLE addresses suitable for carrying out the various steps, processes, methods, and operations described herein is discussed with respect to FIG. 7, any of a variety of systems and/or processes may be utilized in accordance with embodiments of the disclosure. For example, the WLAN controller may rotate the virtual BLE addresses based on specific events, for example, high traffic loads, usage patterns, location of the client device, location of the network devices, or changes in the wireless environment. The elements depicted in FIG. 7 may also be interchangeable with other elements of FIGS. 1-6 and FIGS. 8-9 as required to realize a particularly desired embodiment.

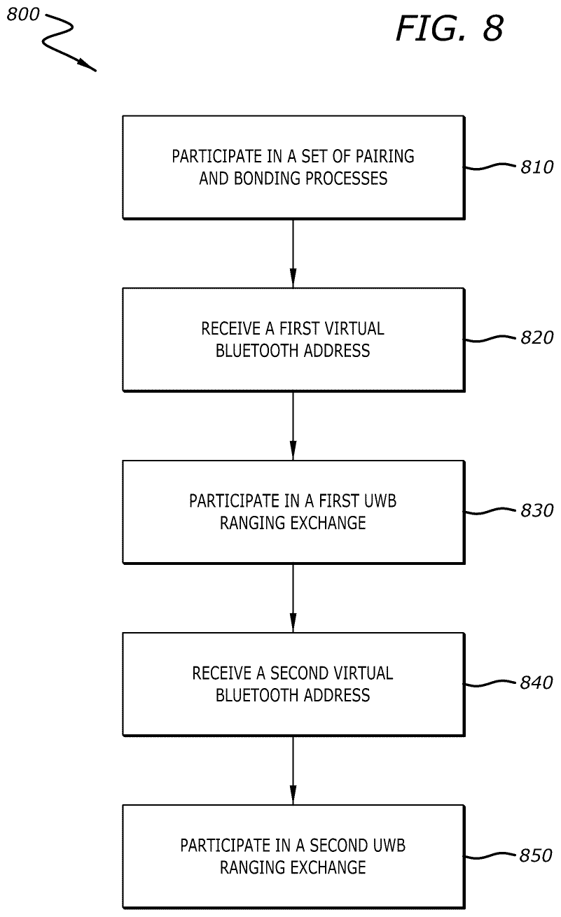

Referring to FIG. 8, a flowchart depicting a process 800 for configuring a network device with different virtual BLE addresses in accordance with various embodiments of the disclosure is shown. In many embodiments, the process 800 may participate in a set of pairing and bonding processes (block 810). In a number of embodiments, the process 800 may participate in the set of pairing and bonding processes associated with virtual Bluetooth addresses, for example, virtual BLE addresses. The virtual BLE addresses with which the client device may be paired and bonded may roam around a site containing multiple network devices. In a variety of embodiments, a virtual BLE address may not be tied to a network device for the roaming function. This bonded virtual BLE address may exist virtually and may be configured to the network device in the deployment by the WLAN controller along with the database of long-term keys bonded with the virtual BLE address. The WLAN controller may execute this configuration to allow the client device to communicate with all the network devices in the network over BLE without having prior knowledge of the existence of each network device. This configuration allows the client device to perceive the same known network device as available for establishing a BLE connection. In various embodiments, for each virtual BLE address in the plurality of virtual Bluetooth addresses, a long-term key may be generated during a respective pairing and bonding process in the set of pairing and bonding processes.

In more embodiments, the process 800 may execute BLE pairing and bonding processes between the client and each network device as follows. The BLE pairing process may include an exchange of information necessary to establish an encrypted BLE connection between the client device and the network device. In additional embodiments, the BLE pairing process may include authenticating the identity of the two devices to be paired, encrypting a communication link between the two devices, and sharing security keys on the encrypted communication link. After pairing, the client device may choose to undergo a BLE bonding process with the network device. In further embodiments, the BLE bonding process may include storing security information exchanged during a successful pairing of the client device with the network device, thereby allowing the devices to reconnect automatically without having to pair again. In still more embodiments, during the bonding processes, the process 800 may generate bonding data. In still further embodiments, the bonding data associated with the virtual Bluetooth address may include the generated long-term key.

In still additional embodiments, the process 800 may receive a first virtual Bluetooth address (block 820). In an example, the first virtual Bluetooth address may be a first virtual BLE address. The first virtual BLE address may not be tied to the network device but may be utilized to represent a different virtual identity or service. In some more embodiments, the process 800 may receive the first virtual BLE address from the WLAN controller. The first virtual BLE address may exist virtually and may be configured to the network device by the WLAN controller along with the database of long-term keys bonded with that first virtual BLE address.

In yet various embodiments, the process 800 may participate in a first UWB ranging exchange (block 830). The process 800 may participate in the first UWB ranging exchange with the client device. The network device may utilize the received first virtual BLE address in its advertisements to establish a BLE connection with the client device. The BLE connection may facilitate BLE communication between the client device and the network device. The process 800 may participate in the first UWB ranging exchange with the client device via the established BLE connection. In yet more embodiments, the first UWB ranging exchange may be a two-way UWB ranging exchange between the client device and the network device.

In still yet more embodiments, the process 800 may generate first UWB ranging exchange data based on the first UWB ranging exchange. In many further embodiments, the first UWB ranging data may include, for example, ToF measurements such as roundtrip time and time stamps, signal transmission and reception information such as time stamps, transmit time, receive time, response time, final receive time, ranging data packet information, or the like. In further examples, the first UWB ranging data may include clock drift corrections, environmental corrections, calculated distances, accuracy and precision metrics, device identifiers, and metadata related to the first UWB ranging exchange. In many additional embodiments, the first UWB ranging data may include first fingerprint data associated with the network device. The first fingerprint data may include a fingerprint, that is, a unique identifier or signature, configured to uniquely identify the network device. In still yet further embodiments, the first fingerprint data may include a MAC address for the network device. The network device may transmit the first fingerprint data to the client device via a set of Bluetooth communications.

In still yet additional embodiments, the process 800 may receive a second virtual Bluetooth address (block 840). In an example, the second virtual Bluetooth address may be a second virtual BLE address. The second virtual BLE address may not be tied to the network device but may be utilized to represent a different virtual identity or service. In several embodiments, the process 800 may receive the second virtual BLE address from the WLAN controller. The second virtual BLE address may exist virtually and may be configured to the network device by the WLAN controller along with the database of long-term keys bonded with that second virtual BLE address. The second virtual BLE address may be different from the first virtual BLE address.

In several more embodiments, the process 800 may participate in a second UWB ranging exchange (block 850). The process 800 may participate in the second UWB ranging exchange with the client device. The network device may utilize the received second virtual BLE address in its advertisements to establish a BLE connection with the client device or another client device that had bonded with the second virtual BLE address. The BLE connection may facilitate BLE communication between the client device and the network device. The process 800 may participate in the second UWB ranging exchange with the client device via the established BLE connection. In numerous embodiments, the second UWB ranging exchange may be a two-way UWB ranging exchange between the client device and the network device.

In numerous additional embodiments, the process 800 may generate second UWB ranging exchange data based on the second UWB ranging exchange. In further additional embodiments, the second UWB ranging data may include, for example, ToF measurements such as roundtrip time and time stamps, signal transmission and reception information such as time stamps, transmit time, receive time, response time, final receive time, ranging data packet information, or the like. In further examples, the second UWB ranging data may include clock drift corrections, environmental corrections, calculated distances, accuracy and precision metrics, device identifiers, and metadata related to the second UWB ranging exchange. In many embodiments, the second UWB ranging data may include second fingerprint data associated with the network device. The second fingerprint data may include a fingerprint, that is, a unique identifier or signature, configured to uniquely identify the network device. In a number of embodiments, the second fingerprint data may include a MAC address for the network device. The network device may transmit the second fingerprint data to the client device via a set of Bluetooth communications.

Although a specific embodiment for a process 800 for configuring a network device with different virtual BLE addresses suitable for carrying out the various steps, processes, methods, and operations described herein is discussed with respect to FIG. 8, any of a variety of systems and/or processes may be utilized in accordance with embodiments of the disclosure. For example, the network device may be configured to operate as a standalone access point that may provide connectivity to the client device, or a multifunction access point that may operate as a combination of two or more access points, or a controlled access point that may operate as a client device of the WLAN controller. The elements depicted in FIG. 8 may also be interchangeable with other elements of FIGS. 1-7 and FIG. 9 as required to realize a particularly desired embodiment.

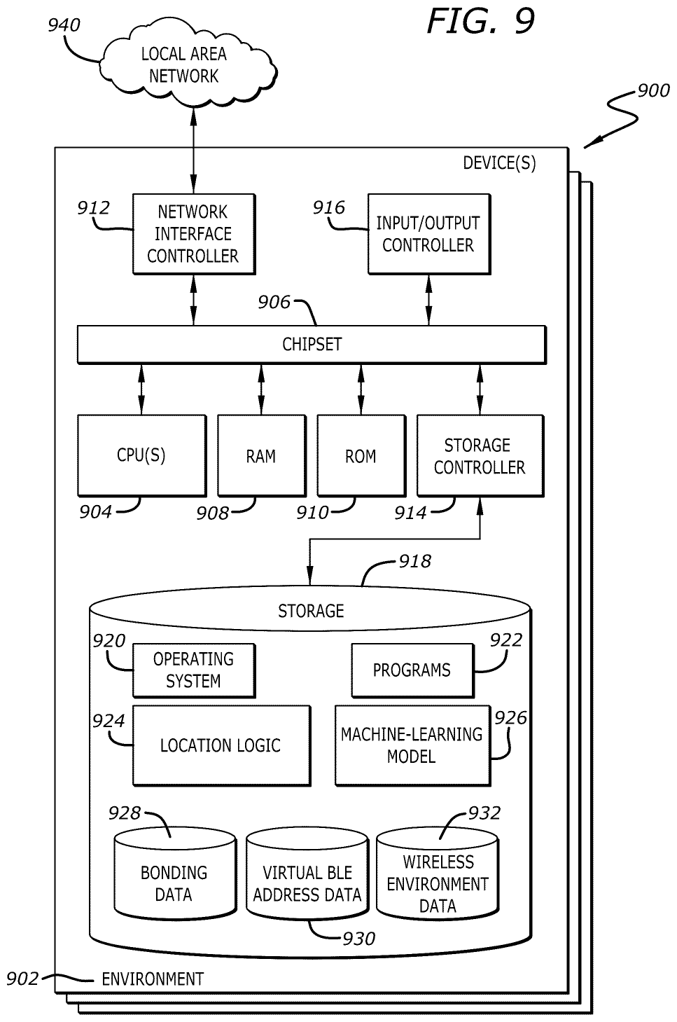

Referring to FIG. 9, a conceptual block diagram of a device 900 capable of executing components and logic for implementing the functionality and embodiments described above is shown. The embodiment of the conceptual block diagram depicted in FIG. 9 can illustrate a conventional server computer, a workstation, a desktop computer, a laptop, a tablet, a network appliance, an electronic reader (e-reader), a smartphone, or other computing device, and can be utilized to execute any of the application and/or logic components presented herein. The device 900 may, in some examples, correspond to a physical device or to a virtual resource described herein. The device 900 can be a network device (for example, an access point or a WLAN controller), a client device, or the like in accordance with various embodiments of the disclosure.

In many embodiments, the device 900 may include an environment 902 such as a baseboard or a “motherboard,” in physical embodiments that can be configured as a printed circuit board with a multitude of components or devices connected by way of a system bus or other electrical communication paths. Conceptually, in virtualized embodiments, the environment 902 may be a virtual environment that encompasses and executes the remaining components and resources of the device 900. In a number of embodiments, one or more processors 904, such as, but not limited to, central processing units (CPUs) can be configured to operate in conjunction with a chipset 906. The processor(s) 904 can be standard programmable CPUs that perform arithmetic and logical operations necessary for the operation of the device 900.

In a variety of embodiments, the processor(s) 904 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 906 may provide an interface between the processor(s) 904 and the remainder of the components and devices within the environment 902. The chipset 906 can provide an interface to a random-access memory (RAM) 908, which can be utilized as the main memory in the device 900 in some embodiments. The chipset 906 can further be configured to provide an interface to a computer-readable storage medium such as a read-only memory (ROM) 910 or a non-volatile RAM (NVRAM) for storing basic routines that can help with various tasks such as, but not limited to, starting up the device 900 and/or transferring information between the various components and devices. The ROM 910 or NVRAM can also store other application components necessary for the operation of the device 900 in accordance with various embodiments described herein.

Different embodiments of the device 900 can be configured to operate in a networked environment using logical connections to remote computing devices and computer systems through a network, such as the network 940. The chipset 906 can include functionality for providing network connectivity through a network interface controller (NIC) 912, which may include a gigabit Ethernet adapter or similar component. The NIC 912 can be capable of connecting the device 900 to other devices over the network 940. It is contemplated that multiple NICs 912 may be present in the device 900, connecting the device 900 to other types of networks and remote systems.

In more embodiments, the device 900 can be connected to a storage 918 that provides non-volatile storage for data accessible by the device 900. The storage 918 can, for example, store an operating system 920, applications or programs 922, bonding data 928, virtual BLE address data 930, and ranging data 932, which are described in greater detail below. The storage 918 can be connected to the environment 902 through a storage controller 914 connected to the chipset 906. In additional embodiments, the storage 918 can include one or more physical storage units. The storage controller 914 can interface with the physical storage units through a serial attached SCSI (SAS) interface, a serial advanced technology attachment (SATA) interface, a fiber channel (FC) interface, or other type of interface for physically connecting and transferring data between computers and physical storage units.

The device 900 can store data within the storage 918 by transforming the physical state of the physical storage units to reflect the information being stored. The specific transformation of physical state can depend on various factors. Examples of such factors can include, but are not limited to, the technology utilized to implement the physical storage units, whether the storage 918 is characterized as primary or secondary storage, and the like.

For example, the device 900 can store information within the storage 918 by issuing instructions through the storage controller 914 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 900 can further read or access information from the storage 918 by detecting the physical states or characteristics of one or more particular locations within the physical storage units.

In addition to the storage 918 described above, the device 900 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 900. In some examples, the operations performed by a cloud computing network, and or any components included therein, may be supported by one or more devices similar to the device 900. Stated otherwise, some or all of the operations performed by the cloud computing network, and or any components included therein, may be performed by one or more devices 900 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (EPROM), electrically-erasable programmable ROM (EEPROM), flash memory or other solid-state memory technology, compact disc ROM (CDROM), digital versatile disk (DVD), high definition DVD (HD-DVD), BLU-RAY, or other optical storage, magnetic cassettes, magnetic tape, magnetic disk storage or other magnetic storage devices, or any other medium that can be utilized to store the desired information in a non-transitory fashion.

As mentioned briefly above, the storage 918 can store an operating system 920 utilized to control the operation of the device 900. According to one embodiment, the operating system 920 includes the LINUX operating system. According to another embodiment, the operating system 920 includes the WINDOWS® SERVER operating system from MICROSOFT Corporation of Redmond, Washington. According to further embodiments, the operating system 920 can include the UNIX operating system or one of its variants. It should be appreciated that other operating systems can also be utilized. The storage 918 can store other system or application programs and data utilized by the device 900.

In further embodiments, the storage 918 or other computer-readable storage media is encoded with computer-executable instructions which, when loaded into the device 900, may transform the device 900 from a general-purpose computing system into a special-purpose computer capable of implementing the embodiments described herein. These computer-executable instructions may be stored as applications or programs 922 and transform the device 900 by specifying how the processor(s) 904 can transition between states, as described above. In still more embodiments, the device 900 has access to computer-readable storage media storing computer-executable instructions which, when executed by the device 900, perform the various processes described above with regard to FIGS. 1-9. In still further embodiments, the device 900 can also include computer-readable storage media having instructions stored thereupon for performing any of the other computer-implemented operations described herein.

In still additional embodiments, the device 900 can also include one or more input/output controllers 916 for receiving and processing input from a number of input devices, such as a keyboard, a mouse, a touchpad, a touch screen, an electronic stylus, or other type of input device. Similarly, an input/output controller 916 can be configured to provide output to a display, such as a computer monitor, a flat panel display, a digital projector, a printer, or other type of output device. Those skilled in the art will recognize that the device 900 may not include all of the components shown in FIG. 9, and can include other components that are not explicitly shown in FIG. 9, or may utilize an architecture completely different than that shown in FIG. 9.

As described above, the device 900 may support a virtualization layer, such as one or more virtual resources executing on the device 900. In some examples, the virtualization layer may be supported by a hypervisor that provides one or more virtual machines running on the device 900 to perform functions described herein. The virtualization layer may generally support a virtual resource that performs at least a portion of the techniques described herein.

In some more embodiments, the device 900 can include a location logic 924 that may be responsible for locationing with Bluetooth-assisted UWB ranging. In embodiments where the device 900 corresponds to a client device, the location logic 924 can be configured to perform various operations such as, but not limited to, configuring a first set of UWB ranging exchanges associated with a first set of network devices based on at least a part of bonding data associated with a plurality of virtual Bluetooth addresses, perform the first set of UWB ranging exchanges, and obtain first UWB ranging data based on the first set of UWB ranging exchanges. In yet various embodiments, the location logic 924 may also be responsible for configuring a second set of UWB ranging exchanges associated with a second set of network devices based on at least a part of the bonding data associated with the plurality of virtual Bluetooth addresses, performing the second set of UWB ranging exchanges, obtaining second UWB ranging data based on the second set of UWB ranging exchanges, and transmitting the first UWB ranging data or the second UWB ranging data.

In yet more embodiments, the device 900 may correspond to a network device such as a WLAN controller. In such embodiments, the location logic 924 can be configured to perform various operations such as, but not limited to, receiving an indication of a plurality of virtual Bluetooth addresses, receiving bonding data associated with the plurality of virtual Bluetooth addresses, configuring a set of network devices in a plurality of network devices with the plurality of virtual Bluetooth addresses and the bonding data, and rotating the plurality of virtual Bluetooth addresses and the bonding data to additional network devices in the plurality of network devices.

In still yet more embodiments, the storage 918 can include bonding data 928. The bonding data 928 may relate to data representative of the pairing and bonding processes executed between a client device and a plurality of network devices. For example, the bonding data 928 may include a unique identifier of the client device, the virtual BLE address associated with each network device to which the client device bonded, and long-term keys generated by the client device and each of the network devices. The bonding data 928 may be utilized by the location logic 924 to configure UWB ranging exchanges for locationing purposes.

In many further embodiments, the storage 918 can include virtual BLE address data 930. The virtual BLE address data 930 may relate to data representative of virtual BLE addressing executed by the device 900. The virtual BLE address data 930 can include, but is not limited to, the virtual BLE addresses associated with the network devices in the wireless environment.

In many additional embodiments, the storage 918 can include ranging data 932. The ranging data 932 may relate to data representative of the two-way ranging executed between the client device and the network devices over UWB. For example, the ranging data 932 may include fingerprint data of the network devices. The fingerprint data may include, for example, a fingerprint, that is, a unique identifier or signature, configured to uniquely identify each of the network devices. In still yet further embodiments, the fingerprint data may include a set of MAC addresses for the network devices.

Finally, in still yet additional embodiments, data may be processed into a format usable by a machine-learning (“ML”) model 926 (e.g., feature vectors), and or other pre-processing techniques. The ML model 926 may be any type of ML model, such as supervised models, reinforcement models, and/or unsupervised models. The ML model 926 may include one or more of linear regression models, logistic regression models, decision trees, Naïve Bayes models, neural networks, k-means cluster models, random forest models, and/or other types of ML models. The ML model 926 may be configured to analyze the bonding data 928, the virtual BLE address data 930, and the ranging data 932 for determining a precise location of the client device. In several embodiments, the ML model 926 may be utilized to identify various parameters to include in the ranging data 932. For example, the ML model 926 may analyze the ranging data 932 and identify parameters that are required to augment the ranging data 932. Once the parameters are identified, the location logic 924 may utilize the parameters to determine a precise location of the client device. In many embodiments, the ML model 926 may facilitate rotation of the plurality of virtual BLE addresses and the bonding data based on historical client device location data to allow these virtual BLE addresses to be physically located near where the client device was previously located. For example, the ML model 926 may be configured to receive historical client device location data as input and identify those network devices in the wireless network that are most likely to be located in proximity or communication range of a roaming client device. The location logic 924 may then rotate the plurality of virtual BLE addresses and the bonding data to configure UWB ranging exchanges with the identified network devices.

Although a specific embodiment for a device 900 suitable for configuration with the location logic 924 for carrying out the various steps, processes, methods, and operations described herein is discussed with respect to FIG. 9, any of a variety of systems and/or processes may be utilized in accordance with embodiments of the disclosure. For example, the device may be implemented in a virtual environment such as a cloud-based network administration suite or a cloud computing environment, or the device may be distributed across a variety of network devices such that each acts as a device and the location logic 924 acts in tandem between the devices. The elements depicted in FIG. 9 may also be interchangeable with other elements of FIGS. 1-8 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A client device, comprising:
a processor;
a network interface controller configured to provide access to a network; and
a memory communicatively coupled to the processor, wherein the memory comprises a location logic that is configured to:
configure a first set of Ultra-Wide Band (UWB) ranging exchanges associated with a first set of network devices based on at least a part of bonding data associated with a plurality of virtual Bluetooth addresses;
perform the first set of UWB ranging exchanges;
obtain first UWB ranging data based on the first set of UWB ranging exchanges;
configure a second set of UWB ranging exchanges associated with a second set of network devices based on at least a part of the bonding data associated with the plurality of virtual Bluetooth addresses;
perform the second set of UWB ranging exchanges;
obtain second UWB ranging data based on the second set of UWB ranging exchanges; and
transmit the first UWB ranging data or the second UWB ranging data.

2. The client device of claim 1, wherein:
a first network device in the first set of network devices and a second network device in the second set of network devices are different network devices,
a first UWB ranging exchange in the first set of UWB ranging exchanges is configured with the first network device based on bonding data associated with a virtual Bluetooth address in the plurality of virtual Bluetooth addresses, and
a second UWB ranging exchange in the second set of UWB ranging exchanges is configured with the second network device based on the bonding data associated with the virtual Bluetooth address in the plurality of virtual Bluetooth addresses.

3. The client device of claim 1, wherein the first set of UWB ranging exchanges and the second set of UWB ranging exchanges comprise two-way UWB ranging exchanges.

4. The client device of claim 1, wherein the plurality of virtual Bluetooth addresses comprises a plurality of virtual Bluetooth Low Energy (BLE) virtual addresses.

5. The client device of claim 1, wherein the location logic is further configured to:
obtain first fingerprint data associated with the first set of network devices;
obtain second fingerprint data associated with the second set of network devices; and
transmit the first fingerprint data or the second fingerprint data.

6. The client device of claim 5, wherein the first fingerprint data and the second fingerprint data are obtained via a set of Bluetooth communications.

7. The client device of claim 5, wherein the first fingerprint data comprises a first set of Media Access Control (MAC) addresses for the first set of network devices, and the second fingerprint data comprises a second set of MAC addresses for the second set of network devices.

8. The client device of claim 5, wherein the location logic is further configured to:
receive a first location determination for the client device based on the first UWB ranging data and the first fingerprint data; or
receive a second location determination for the client device based on the second UWB ranging data and the second fingerprint data.

9. The client device of claim 8, wherein one or more of the first UWB ranging data, the first fingerprint data, the second UWB ranging data, or the second fingerprint data are transmitted to a network device, and the first location determination or the second location determination is received from the network device.

10. The client device of claim 1, wherein the bonding data associated with the plurality of virtual Bluetooth addresses comprises, for each virtual Bluetooth address, a long-term key.

11. The client device of claim 10, wherein the location logic is further configured to participate in a set of pairing and bonding processes associated with the plurality of virtual Bluetooth addresses.

12. The client device of claim 11, wherein for each virtual Bluetooth address in the plurality of virtual Bluetooth addresses, the long-term key is generated during a respective pairing and bonding process in the set of pairing and bonding processes.

13. The client device of claim 11, wherein the bonding data associated with the plurality of virtual Bluetooth addresses is stored during the set of pairing and bonding processes.

14. A network device, comprising:
a processor;
a network interface controller configured to provide access to a network; and
a memory communicatively coupled to the processor, wherein the memory comprises a location logic that is configured to:
receive an indication of a plurality of virtual Bluetooth addresses;
receive bonding data associated with the plurality of virtual Bluetooth addresses, wherein the bonding data is further associated with one or more client devices;
configure a set of network devices in a plurality of network devices with the plurality of virtual Bluetooth addresses and the bonding data; and
rotate the plurality of virtual Bluetooth addresses and the bonding data to additional network devices in the plurality of network devices.

15. The network device of claim 14, wherein the plurality of virtual Bluetooth addresses comprises a plurality of virtual Bluetooth Low Energy (BLE) addresses.

16. The network device of claim 14, wherein the plurality of network devices is under management by the network device.

17. The network device of claim 14, wherein the bonding data associated with the plurality of virtual Bluetooth addresses comprises, for each pair comprising a virtual Bluetooth address and a client device, a long-term key.

18. The network device of claim 14, wherein the location logic is further configured to store the plurality of virtual Bluetooth addresses and the bonding data in a datastore.

19. The network device of claim 14, wherein the plurality of virtual Bluetooth addresses and the bonding data are rotated based on at least one of historical client device location data or a machine learning process.

20. A method for determining a location of a client device, comprising:
configuring a first set of Ultra-Wide Band (UWB) ranging exchanges associated with a first set of network devices based on at least a part of bonding data associated with a plurality of virtual Bluetooth addresses;
performing the first set of UWB ranging exchanges;
obtaining first UWB ranging data based on the first set of UWB ranging exchanges;
configuring a second set of UWB ranging exchanges associated with a second set of network devices based on at least a part of the bonding data associated with the plurality of virtual Bluetooth addresses;
performing the second set of UWB ranging exchanges;
obtaining second UWB ranging data based on the second set of UWB ranging exchanges; and
transmitting the first UWB ranging data or the second UWB ranging data.
